(19) United States
(12) Patent Application Publication
(10) Pub. No.: US 2021/0201148 A1
(43) Pub. Date: Jul. 1, 2021

(54) METHOD, APPARATUS, AND STORAGE MEDIUM FOR PREDICTING INFORMATION

(71) Applicant: TENCENT TECHNOLOGY (SHENZHEN) COMPANY LIMITED, Shenzhen (CN)

(72) Inventors: Hongliang LI, Shenzhen (CN); Liang WANG, Shenzhen (CN); Tengfei SHI, Shenzhen (CN); Bo YUAN, SHENZHEN (CN); Shaojie YANG, SHENZHEN (CN); Hongsheng YU, Shenzhen (CN); Yinyuting YIN, Shenzhen (CN)

(73) Assignee: TENCENT TECHNOLOGY (SHENZHEN) COMPANY LIMITED, SHENZHEN (CN)

(21) Appl. No.: 17/201,152

(22) Filed: Mar. 15, 2021

Related U.S. Application Data
(63) Continuation of application No. PCT/CN2019/124681, filed on Dec. 11, 2019.

(30) Foreign Application Priority Data
Dec. 13, 2018 (CN) 201811526060.1

(51) Int. Cl. G06N 3/08; G06K 9/62

(52) U.S. Cl. CPC G06N 3/08; G06K 9/6232; G06K 9/6288; G06K 9/6256

(57) ABSTRACT

A method, apparatus, and storage medium for predicting information are described. The method for obtaining a combined model includes obtaining, a to-be-trained image set including N to-be-trained images; extracting a to-be-trained feature set from each to-be-trained image, the to-be-trained feature set comprising a first, second, and third to-be-trained feature, the first to-be-trained feature representing an image feature of a first region, the second to-be-trained feature representing an image feature of a second region, the third to-be-trained feature representing an attribute feature related to an interaction operation, and the first region being smaller than the second region; obtaining a first to-be-trained label and a second to-be-trained label that correspond to the each to-be-trained image; and obtaining a combined model through training according to the to-be-trained feature set in the each to-be-trained image and the first to-be-trained label and the second to-be-trained label that correspond to the each to-be-trained image.

### RELATED APPLICATION

This application is a continuation application of PCT Patent Application No. PCT/CN2019/124681, filed on Dec. 11, 2019, which claims priority to Chinese Patent Application No. 201811526060.1, filed on Dec. 13, 2018, both of which are incorporated herein by reference in their entireties.

### FIELD OF THE TECHNOLOGY

This application relates to the field of artificial intelligence (AI) technologies, and in particular, to an information prediction method, a model training method, and a server.

### BACKGROUND OF THE DISCLOSURE

AI programs have defeated top professional players in board games having clear rules. By contrast, operations in multiplayer online battle arena (MOBA) games are more complex and are closer to a scene in a real word. To overcome AI problems in the MOBA games helps to explore and resolve complex problems in the real world.

Based on the complexity of the operations of the MOBA games, operations in a whole MOBA game may generally be divided into two types, namely, big picture operations and micro control operations, to reduce a complexity degree of the whole MOBA game. Referring to FIG. 1, FIG. 1 is a schematic diagram of creating a model hierarchically in the related art. As shown in FIG. 1, division is performed according to big picture decisions such as “jungle”, “farm”, “teamfight” and “push”, where in each round of game, there are approximately 100 big picture tasks on average, and a number of steps of micro control decisions in each big picture task is approximately 200 on average. Based on the above, referring to FIG. 2, FIG. 2 is a schematic structural diagram of a hierarchical model in the related art. As shown in FIG. 2, a big picture model is established by using big picture features, and a micro control model is established by using micro control features. A big picture label may be outputted by using the big picture model, and a micro control label may be outputted by using the micro control model.

There are some issues/problems with the models. For example but not limited to, the big picture model and the micro control model need to be designed and trained respectively during hierarchical modeling. That is, the two models are mutually independent, and in an actual application, which model is selected for prediction needs to be determined. Therefore, a hard handover problem exists between the two models, which is adverse to the convenience of prediction.

The present disclosure describes various embodiments for providing an information prediction method and/or a model training method to predict micro control and a big picture by using only one combined model, addressing at least one of the issues/problems discussed above. For example, the various embodiments in the present disclosure may effectively resolve a hard handover problem in a hierarchical model and/or may improve the convenience of prediction.

### SUMMARY

Embodiments of this application provide an information prediction method, a model training method, and a server, to predict micro control and a big picture by using only one combined model, thereby effectively resolving a hard handover problem in a hierarchical model and improving the convenience of prediction.

The present disclosure describes a method for obtaining a combined model. The method includes obtaining, by a device, a to-be-trained image set, the to-be-trained image set comprising N to-be-trained images, N being an integer greater than or equal to 1. The device includes a memory storing instructions and a processor in communication with the memory. The method also includes extracting, by the device, a to-be-trained feature set from each to-be-trained image, the to-be-trained feature set comprising a first to-be-trained feature, a second to-be-trained feature, and a third to-be-trained feature, the first to-be-trained feature representing an image feature of a first region, the second to-be-trained feature representing an image feature of a second region, the third to-be-trained feature representing an attribute feature related to an interaction operation, and a range of the first region being smaller than a range of the second region; obtaining, by the device, a first to-be-trained label and a second to-be-trained label that correspond to the each to-be-trained image, the first to-be-trained label representing a label related to operation content, and the second to-be-trained label representing a label related to an operation intention; and obtaining, by the device, a combined model through training according to the to-be-trained feature set in the each to-be-trained image and the first to-be-trained label and the second to-be-trained label that correspond to the each to-be-trained image.

The present disclosure describes an apparatus for obtaining a combined model. The apparatus includes a memory storing instructions; and a processor in communication with the memory. When the processor executes the instructions, the processor is configured to cause the apparatus to: obtain a to-be-trained image set, the to-be-trained image set comprising N to-be-trained images, N being an integer greater than or equal to 1, extract a to-be-trained feature set from each to-be-trained image, the to-be-trained feature set comprising a first to-be-trained feature, a second to-be-trained feature, and a third to-be-trained feature, the first to-be-trained feature representing an image feature of a first region, the second to-be-trained feature representing an image feature of a second region, the third to-be-trained feature representing an attribute feature related to an interaction operation, and a range of the first region being smaller than a range of the second region, obtain a first to-be-trained label and a second to-be-trained label that correspond to the each to-be-trained image, the first to-be-trained label representing a label related to operation content, and the second to-be-trained label representing a label related to an operation intention, and obtain a combined model through training according to the to-be-trained feature set in the each to-be-trained image and the first to-be-trained label and the second to-be-trained label that correspond to the each to-be-trained image.

The present disclosure describes a non-transitory computer-readable storage medium storing computer-readable instructions. The computer-readable instructions, when executed by a processor, are configured to cause the processor to perform: obtaining a to-be-trained image set, the to-be-trained image set comprising N to-be-trained images, N being an integer greater than or equal to 1; extracting a to-be-trained feature set from each to-be-trained image, the to-be-trained feature set comprising a first to-be-trained feature, a second to-be-trained feature, and a third to-be-trained feature, the first to-be-trained feature representing an image feature of a first region, the second to-be-trained feature representing an image feature of a second region, the third to-be-trained feature representing an attribute feature related to an interaction operation, and a range of the first region being smaller than a range of the second region; obtaining a first to-be-trained label and a second to-be-trained label that correspond to the each to-be-trained image, the first to-be-trained label representing a label related to operation content, and the second to-be-trained label representing a label related to an operation intention; and obtaining a combined model through training according to the to-be-trained feature set in the each to-be-trained image and the first to-be-trained label and the second to-be-trained label that correspond to the each to-be-trained image.

Another aspect of the present disclosure provides an information prediction method, including: obtaining a to-be-predicted image; extracting a to-be-predicted feature set from the to-be-predicted image, the to-be-predicted feature set including a first to-be-predicted feature, a second to-be-predicted feature, and a third to-be-predicted feature, the first to-be-predicted feature representing an image feature of a first region, the second to-be-predicted feature representing an image feature of a second region, the third to-be-predicted feature representing an attribute feature related to an interaction operation, and a range of the first region being smaller than a range of the second region; and obtaining, by using a target combined model, a first label and/or a second label that correspond or corresponds to the to-be-predicted feature set, the first label representing a label related to operation content, and the second label representing a label related to an operation intention.

Another aspect of the present disclosure provides a model training method, including: obtaining a to-be-trained image set, the to-be-trained image set including N to-be-trained images, N being an integer greater than or equal to 1; extracting a to-be-trained feature set from each to-be-trained image, the to-be-trained feature set including a first to-be-trained feature, a second to-be-trained feature, and a third to-be-trained feature, the first to-be-trained feature representing an image feature of a first region, the second to-be-trained feature representing an image feature of a second region, the third to-be-trained feature representing an attribute feature related to an interaction operation, and a range of the first region being smaller than a range of the second region; obtaining a first to-be-trained label and a second to-be-trained label that correspond to the each to-be-trained image, the first to-be-trained label representing a label related to operation content, and the second to-be-trained label representing a label related to an operation intention; and obtaining a target combined model through training according to the to-be-trained feature set in the each to-be-trained image and the first to-be-trained label and the second to-be-trained label that correspond to the each to-be-trained image.

Another aspect of the present disclosure provides a server, including:

an obtaining module, configured to obtain a to-be-predicted image; and

an extraction module, configured to extract a to-be-predicted feature set from the to-be-predicted image obtained by the obtaining module, the to-be-predicted feature set including a first to-be-predicted feature, a second to-be-predicted feature, and a third to-be-predicted feature, the first to-be-predicted feature representing an image feature of a first region, the second to-be-predicted feature representing an image feature of a second region, the third to-be-predicted feature representing an attribute feature related to an interaction operation, and a range of the first region being smaller than a range of the second region,

the obtaining module being further configured to obtain, by using a target combined model, a first label and a second label that correspond to the to-be-predicted feature set extracted by the extraction module, the first label representing a label related to operation content, and the second label representing a label related to an operation intention.

Optionally, one implementation for the aspect of the present disclosure may include that,

the obtaining module is configured to obtain, by using the target combined model, the first label, the second label, and a third label that correspond to the to-be-predicted feature set, the third label representing a label related to a victory or a defeat.

Another aspect of the present disclosure provides a server, including:

an obtaining module, configured to obtain a to-be-trained image set, the to-be-trained image set including N to-be-trained images, N being an integer greater than or equal to 1;

an extraction module, configured to extract a to-be-trained feature set from each to-be-trained image obtained by the obtaining module, the to-be-trained feature set including a first to-be-trained feature, a second to-be-trained feature, and a third to-be-trained feature, the first to-be-trained feature representing an image feature of a first region, the second to-be-trained feature representing an image feature of a second region, the third to-be-trained feature representing an attribute feature related to an interaction operation, and a range of the first region being smaller than a range of the second region,

the obtaining module being configured to obtain a first to-be-trained label and a second to-be-trained label that correspond to the each to-be-trained image, the first to-be-trained label representing a label related to operation content, and the second to-be-trained label representing a label related to an operation intention; and

a training module, configured to obtain a target combined model through training according to the to-be-trained feature set extracted by the extraction module from the each to-be-trained image and the first to-be-trained label and the second to-be-trained label that are obtained by the obtaining module and that correspond to the each to-be-trained image.

Optionally, one implementation for the aspect of the present disclosure may include that,

the first to-be-trained feature is a two-dimensional vector feature, and the first to-be-trained feature includes at least one of character position information, moving object position information, fixed object position information, and defensive object position information in the first region;

the second to-be-trained feature is a two-dimensional vector feature, and the second to-be-trained feature includes at least one of character position information, moving object position information, fixed object position information, defensive object position information, obstacle object position information, and output object position information in the second region;

the third to-be-trained feature is a one-dimensional vector feature, and the third to-be-trained feature includes at least one of a character hit point value, a character output value, time information, and score information; and there is a correspondence between the first to-be-trained feature, the second to-be-trained feature, and the third to-be-trained feature.

Optionally, another implementation for the aspect of the present disclosure may include that,

the first to-be-trained label includes key type information and/or key parameter information; and

the key parameter information includes at least one of a direction-type parameter, a position-type parameter, and a target-type parameter, the direction-type parameter being used for representing a moving direction of a character, the position-type parameter being used for representing a position of the character, and the target-type parameter being used for representing a to-be-outputted object of the character.

Optionally, another implementation for the aspect of the present disclosure may include that, the second to-be-trained label includes operation intention information and character position information; and the operation intention information represents an intention with which a character interacts with an object, and the character position information represents a position of the character in the first region.

Optionally, another implementation for the aspect of the present disclosure may include that, the training module is configured to process the to-be-trained feature set in the each to-be-trained image to obtain a target feature set, the target feature set including a first target feature, a second target feature, and a third target feature;

obtain a first predicted label and a second predicted label that correspond to the target feature set by using a long short-term memory (LSTM) layer, the first predicted label representing a label that is obtained through prediction and that is related to the operation content, and the second predicted label representing a label that is obtained through prediction and that is related to the operation intention;

obtain a model core parameter through training according to the first predicted label, the first to-be-trained label, the second predicted label, and the second to-be-trained label of the each to-be-trained image, both the first predicted label and the second predicted label being predicted values, and both the first to-be-trained label and the second to-be-trained label being true values; and

generate the target combined model according to the model core parameter.

Optionally, another implementation for the aspect of the present disclosure may include that, the training module is configured to process the third to-be-trained feature in the each to-be-trained image by using a fully connected layer to obtain the third target feature, the third target feature being a one-dimensional vector feature;

process the second to-be-trained feature in the each to-be-trained image by using a convolutional layer to obtain the second target feature, the second target feature being a one-dimensional vector feature; and

process the first to-be-trained feature in the each to-be-trained image by using the convolutional layer to obtain the first target feature, the first target feature being a one-dimensional vector feature.

Optionally, another implementation for the aspect of the present disclosure may include that, the training module is configured to obtain a first predicted label, a second predicted label, and a third predicted label that correspond to the target feature set by using the LSTM layer, the third predicted label representing a label that is obtained through prediction and that is related to a victory or a defeat;

obtain a third to-be-trained label corresponding to the each to-be-trained image, the third to-be-trained label being used for representing an actual victory or defeat; and

obtain the model core parameter through training according to the first predicted label, the first to-be-trained label, the second predicted label, the second to-be-trained label, the third predicted label, and the third to-be-trained label, the third to-be-trained label being a predicted value, and the third predicted label being a true value.

Optionally, another implementation for the aspect of the present disclosure may include that, the server further includes an update module;

the obtaining module is further configured to obtain a to-be-trained video after the training module obtains the target combined model through training according to the to-be-trained feature set in the each to-be-trained image and the first to-be-trained label and the second to-be-trained label that correspond to the each to-be-trained image, the to-be-trained video includes a plurality of frames of interaction images;

the obtaining module is further configured to obtain target scene data corresponding to the to-be-trained video by using the target combined model, the target scene data including related data in a target scene;

the training module is further configured to obtain a target model parameter through training according to the target scene data, the first to-be-trained label, and the first predicted label that are obtained by the obtaining module, the first predicted label representing a label that is obtained through prediction and that is related to the operation content, the first predicted label being a predicted value, and the first to-be-trained label being a true value; and

the update module is configured to update the target combined model by using the target model parameter that is obtained by the training module, to obtain a reinforced combined model.

Optionally, another implementation for the aspect of the present disclosure may include that, the server further includes an update module;

the obtaining module is further configured to obtain a to-be-trained video after the training module obtains the target combined model through training according to the to-be-trained feature set in the each to-be-trained image and the first to-be-trained label and the second to-be-trained label that correspond to the each to-be-trained image, the to-be-trained video includes a plurality of frames of interaction images;

the obtaining module is further configured to obtain target scene data corresponding to the to-be-trained video by using the target combined model, the target scene data including related data in a target scene;

the training module is further configured to obtain a target model parameter through training according to the target scene data, the second to-be-trained label, and the second predicted label that are obtained by the obtaining module, the second predicted label representing a label that is obtained through prediction and that is related to the operation intention, the second predicted label being a predicted value, and the second to-be-trained label being a true value; and

the update module is configured to update the target combined model by using the target model parameter that is obtained by the training module, to obtain a reinforced combined model.

Another aspect of the present disclosure provides a server, the server being configured to perform the information prediction method according to the first aspect or any possible implementation of the first aspect. Specifically, the server may include modules configured to perform the information prediction method according to the first aspect or any possible implementation of the first aspect.

Another aspect of the present disclosure provides a server, the server being configured to perform the model training method according to the second aspect or any possible implementation of the second aspect. For example, the server may include modules configured to perform the model training method according to the second aspect or any possible implementation of the second aspect.

Another aspect of the present disclosure provides a computer-readable storage medium, the computer-readable storage medium storing instructions, the instructions, when run on a computer, causing the computer to perform the method according to any one of the foregoing aspects.

Another aspect of the present disclosure provides a computer program (product), the computer program (product) including computer program code, the computer program code, when executed by a computer, causing the computer to perform the method according to any one of the foregoing aspects.

As can be seen from the foregoing technical solutions, the embodiments of this application have at least the following advantages:

In the embodiments of this application, an information prediction method is provided. First, a server obtains a to-be-predicted image; then extracts a to-be-predicted feature set from the to-be-predicted image, where the to-be-predicted feature set includes a first to-be-predicted feature, a second to-be-predicted feature, and a third to-be-predicted feature, the first to-be-predicted feature represents an image feature of a first region, the second to-be-predicted feature represents an image feature of a second region, the third to-be-predicted feature represents an attribute feature related to an interaction operation, and a range of the first region is smaller than a range of the second region; and finally, the server may obtain, by using a target combined model, a first label and a second label that correspond to the to-be-predicted image, where the first label represents a label related to operation content, and the second label represents a label related to an operation intention. According to the foregoing manners micro control and a big picture may be predicted by using only one combined model, where a prediction result of the micro control is represented as the first label, and a prediction result of the big picture is represented as the second label. Therefore, a big picture model and a micro control model are merged into one combined model, thereby effectively resolving a hard handover problem in a hierarchical model and improving the convenience of prediction.

### BRIEF DESCRIPTION OF THE DRAWINGS

FIG. 1 is a schematic diagram of creating a model hierarchically in the related art.

FIG. 2 is a schematic structural diagram of a hierarchical model in the related art.

FIG. 3 is a schematic architectural diagram of an information prediction system according to an embodiment of this application.

FIG. 4 is a schematic diagram of a system structure of a combined model according to an embodiment of this application.

FIG. 5 is a schematic diagram of an embodiment of an information prediction method according to an embodiment of this application.

FIG. 6 is a schematic diagram of a work flow of a reinforced combined model according to an embodiment of this application.

FIG. 7 is a schematic diagram of an embodiment of a model training method according to an embodiment of this application.

FIG. 8 is a schematic diagram of an embodiment of extracting a to-be-trained feature set according to an embodiment of this application.

FIG. 9 is a schematic diagram of a feature expression of a to-be-trained feature set according to an embodiment of this application.

FIG. 10 is a schematic diagram of an image-like feature expression according to an embodiment of this application.

FIG. 11 is a schematic diagram of a micro control label according to an embodiment of this application.

FIG. 12 is another schematic diagram of a micro control label according to an embodiment of this application.

FIG. 13 is another schematic diagram of a micro control label according to an embodiment of this application.

FIG. 14 is another schematic diagram of a micro control label according to an embodiment of this application.

FIG. 15 is a schematic diagram of a big picture label according to an embodiment of this application.

FIG. 16 is a schematic diagram of a network structure of a combined model according to an embodiment of this application.

FIG. 17 is a schematic diagram of a system structure of a reinforced combined model according to an embodiment of this application.

FIG. 18 is a schematic diagram of another system structure of a reinforced combined model according to an embodiment of this application.

FIG. 19 is a schematic diagram of an embodiment of a server according to an embodiment of this application.

FIG. 20 is a schematic diagram of another embodiment of a server according to an embodiment of this application.

FIG. 21 is a schematic diagram of another embodiment of a server according to an embodiment of this application.

FIG. 22 is a schematic structural diagram of a server according to an embodiment of this application.

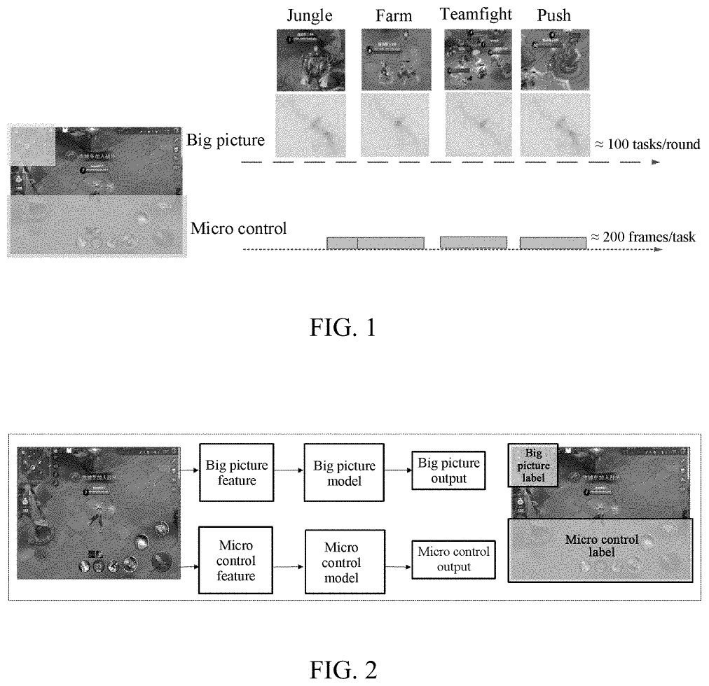

### DESCRIPTION OF EMBODIMENTS

Embodiments of this application provide an information prediction method, a model training method, and a server, to predict micro control and a big picture by using only one combined model, thereby effectively resolving a hard handover problem in a hierarchical model and improving the convenience of prediction.

In the specification, claims, and accompanying drawings of this application, the terms “first”, “second”, “third”, “fourth”, and the like (if existing) are intended to distinguish between similar objects rather than describe a specific sequence or a precedence order. It may be understood that the data termed in such a way is interchangeable in proper circumstances, so that the embodiments of this application described herein, for example, can be implemented in other sequences than the sequence illustrated or described herein. Moreover, the terms “comprise”, “include” and any other variants thereof are intended to cover the non-exclusive inclusion. For example, a process, method, system, product, or device that includes a list of steps or units is not necessarily limited to those expressly listed steps or units, but may include other steps or units not expressly listed or inherent to such a process, method, product, or device.

It is to be understood that models included in this application are applicable to the field of AI, and an application range thereof includes, but is not limited to, machine translation, intelligent control, expert systems, robots, language and image understanding, automatic programming, aerospace application, processing, storage and management of massive information, and the like. For ease of introduction, introduction is made by using an online game scene as an example in this application, and the online game scene may be a scene of a MOBA game. For the MOBA game, an AI model is designed in the embodiments of this application, can better simulate behaviors of a human player, and produces better effects in all of the situations such as a human-computer battle, simulating a disconnected player, and practicing a game character by a player. Typical gameplay of the MOBA game is a multiplayer versus multiplayer mode. That is, two (or more) teams with same number of players compete against each other, where each player controls a hero character, and one party that first pushes the “Nexus” base of the opponent down is a winner.

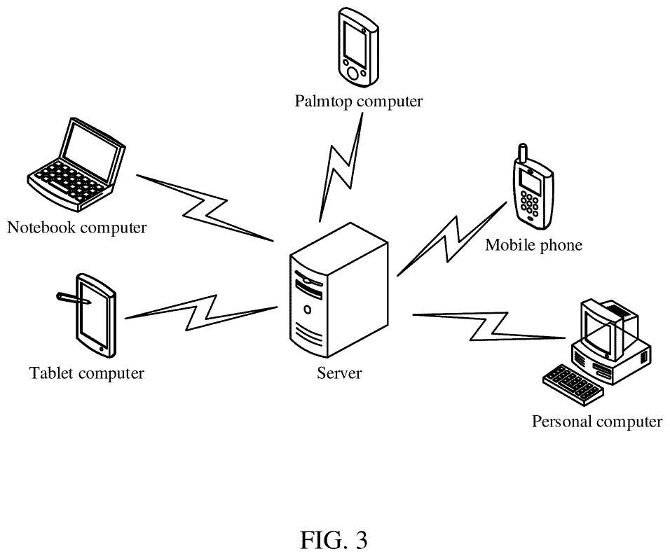

For ease of understanding, this application provides an information prediction method, and the method is applicable to an information prediction system shown in FIG. 3. Referring to FIG. 3, FIG. 3 is a schematic architectural diagram of an information prediction system according to an embodiment of this application. As shown in FIG. 3, a plurality of rounds of games are played on clients, a large amount of game screen data (that is, to-be-trained images) is generated, and then the game screen data is sent to a server. The game screen data may be data generated by human players in an actual game playing process, or may be data obtained by a machine after simulating operations of human players. In this application, the game screen data is mainly formed by data provided by human players. Calculation is performed by using an example in which one round of game is 30 minutes on average and each second includes 15 frames, so that each round of game has 27000 frames of images on average. Training is performed by mainly selecting data related to big picture tasks and micro control tasks in this application to reduce complexity of data. The big picture tasks are divided according to operation intentions, and big picture tasks include, but are not limited to, “jungle”, “farm”, “teamfight”, and “push”. In each round of game, there are only approximately 100 big picture tasks on average, and a number of steps of a micro control decision in each big picture task is approximately 200. Therefore, both a number of steps of a big picture decision and a number of steps of a micro control decision fall within an acceptable range.

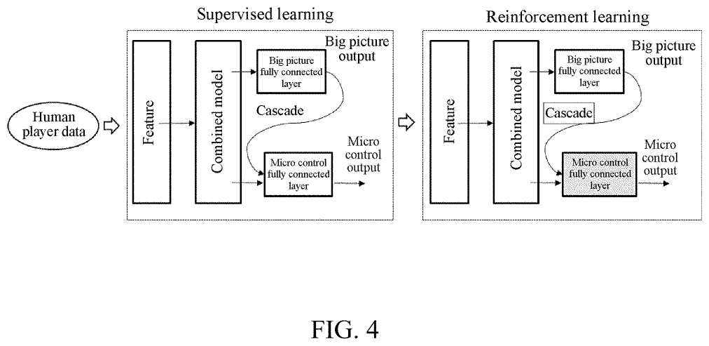

The server trains a model by using the game screen data reported by the clients, and further generates a reinforced combined model based on obtaining a combined model. For ease of introduction, referring to FIG. 4, FIG. 4 is a schematic diagram of a system structure of a reinforced combined model according to an embodiment of this application. As shown in FIG. 4, a whole model training process may be divided into two stages. An initial combined model of big picture and micro control operations is first learned from game data of human players through supervised learning, and a big picture fully connected (FC) layer and a micro control FC layer are added to the combined model, to obtain a combined model. The micro control FC layer (or a big picture FC layer) is then optimized through reinforcement learning, and parameters of other layers are maintained fixed, to improve core indicators, such as an ability hit rate and an ability dodge success rate, in “teamfight”.

The client is deployed on a terminal device. The terminal device includes, but is not limited to, a tablet computer, a notebook computer, a palmtop computer, a mobile phone, and a personal computer (PC), and is not limited herein.

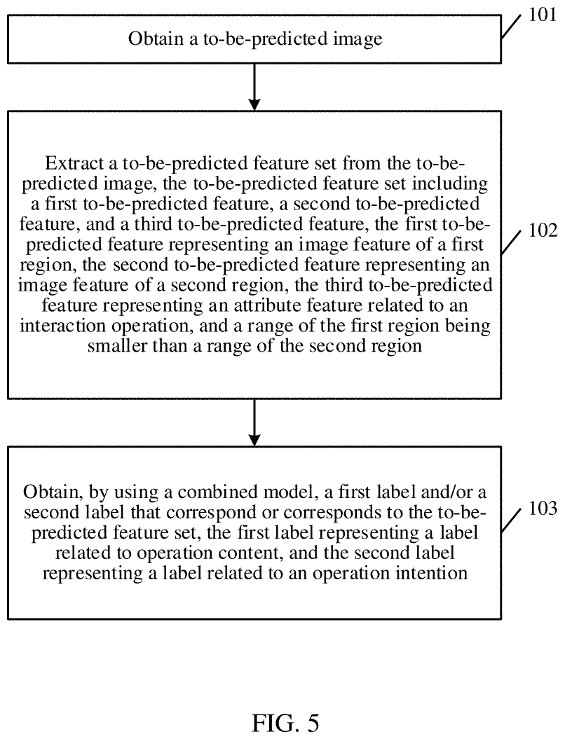

The information prediction method in this application is introduced below with reference to the foregoing introduction. Referring to FIG. 5, an embodiment of the information prediction method in the embodiments of this application includes the following steps:

101: Obtain a to-be-predicted image.

In this embodiment, the server first obtains a to-be-predicted image, and the to-be-predicted image may refer to an image in a MOBA game.

102. Extract a to-be-predicted feature set from the to-be-predicted image, the to-be-predicted feature set including a first to-be-predicted feature, a second to-be-predicted feature, and a third to-be-predicted feature, the first to-be-predicted feature representing an image feature of a first region, the second to-be-predicted feature representing an image feature of a second region, the third to-be-predicted feature representing an attribute feature related to an interaction operation, and a range of the first region being smaller than a range of the second region.

In this embodiment, the server needs to extract a to-be-predicted feature set from the to-be-predicted image, and the to-be-predicted feature set herein mainly includes three types of features, respectively, a first to-be-predicted feature, a second to-be-predicted feature, and a third to-be-predicted feature. The first to-be-predicted feature represents an image feature of a first region. For example, the first to-be-predicted feature is a minimap image-like feature in the MOBA game. The second to-be-predicted feature represents an image feature of a second region. For example, the second to-be-predicted feature is a current visual field image-like feature in the MOBA game. The third to-be-predicted feature represents an attribute feature related to an interaction operation. For example, the third to-be-predicted feature is a hero attribute vector feature in the MOBA game.

103. Obtain, by using a combined model, a first label and/or a second label that correspond or corresponds to the to-be-predicted feature set, the first label representing a label related to operation content, and the second label representing a label related to an operation intention. In one implementation, the combined model may be referred as a target combined model.

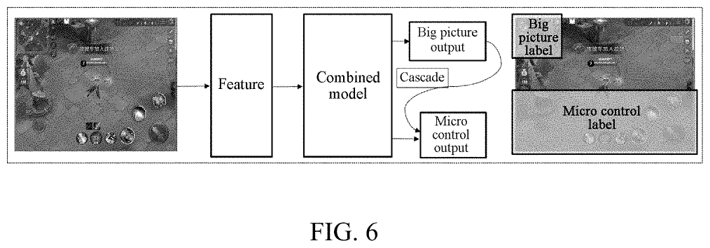

In this embodiment, the server inputs the extracted to-be-predicted feature set into a combined model. Further, the extracted to-be-predicted feature set may alternatively be inputted into a reinforced combined model after reinforcement. The reinforced combined model is a model obtained by reinforcing the combined model. For ease of understanding, referring to FIG. 6, FIG. 6 is a schematic diagram of a work flow of a combined model according to an embodiment of this application. As shown in FIG. 6, in this application, a big picture model and a micro control model are merged into the same model, that is, a combined model. The big picture FC layer and the micro control FC layer are added to the combined model to obtain the combined model, to better meet a decision process of human. Features are inputted into the combined model in a unified manner, that is, a to-be-predicted feature set is inputted. A unified encoding layer is learned, and big picture tasks and micro control tasks are learned at the same time. Output of the big picture tasks is inputted into an encoding layer of the micro control tasks in a cascaded manner, and the combined model may finally only output the first label related to operation content and use output of the micro control FC layer as an execution instruction according to the first label. Alternatively, the combined model may only output the second label related to an operation intention and use output of the big picture FC layer as an execution instruction according to the second label. Alternatively, the combined model may output the first label and the second label at the same time, that is, use output of the micro control FC layer and output the big picture FC layer as an execution instruction according to the first label and the second label at the same time.

In the embodiments of this application, an information prediction method is provided. A server first obtains a to-be-predicted image. The server then extracts a to-be-predicted feature set from the to-be-predicted image. The to-be-predicted feature set includes a first to-be-predicted feature, a second to-be-predicted feature, and a third to-be-predicted feature, the first to-be-predicted feature represents an image feature of a first region, the second to-be-predicted feature represents an image feature of a second region, the third to-be-predicted feature represents an attribute feature related to an interaction operation, and a range of the first region is smaller than a range of the second region. Finally, the server may obtain, by using a combined model, a first label and a second label that correspond to the to-be-predicted image. The first label represents a label related to operation content, and the second label represents a label related to an operation intention. According to the foregoing manners micro control and a big picture may be predicted by using only one combined model, where a prediction result of the micro control is represented as the first label, and a prediction result of the big picture is represented as the second label. Therefore, a big picture model and a micro control model are merged into one combined model, thereby effectively resolving a hard handover problem in a hierarchical model and improving the convenience of prediction.

Optionally, based on the embodiment corresponding to FIG. 5, in a first optional embodiment of the information prediction method according to an embodiment of this application, the obtaining, by using a combined model, a first label and/or a second label that correspond or corresponds to the to-be-predicted feature set may include: obtaining, by using the combined model, a first label, a second label, and a third label that correspond to the to-be-predicted feature set, where the third label represents a label related to a victory or a defeat.

In this embodiment, a relatively comprehensive prediction manner is provided. That is, the first label, the second label, and the third label are outputted at the same time by using the combined model, so that not only operations under the big picture tasks and operations under the micro control tasks can be predicted, but also a victory or a defeat can be predicted.

Optionally, in an actual application, a plurality of consecutive frames of to-be-predicted images are generally inputted, to improve the accuracy of prediction. For example, 100 frames of to-be-predicted images are inputted, and feature extraction is performed on each frame of to-be-predicted image, so that 100 to-be-predicted feature sets are obtained. The 100 to-be-predicted feature sets are inputted into the combined model, to predict an implicit intention related to a big picture task, learn a general navigation capability, predict an execution instruction of a micro control task, and predict a possible victory or defeat of this round of game. For example, one may win this round of game or may lose this round of game.

In the embodiments of this application, the combined model not only can output the first label and the second label, but also can further output the third label. That is, the combined model can further predict a victory or a defeat. According to the foregoing manners, in an actual application, a result of a situation may be better predicted, which helps to improve the reliability of prediction and improve the flexibility and practicability of prediction.

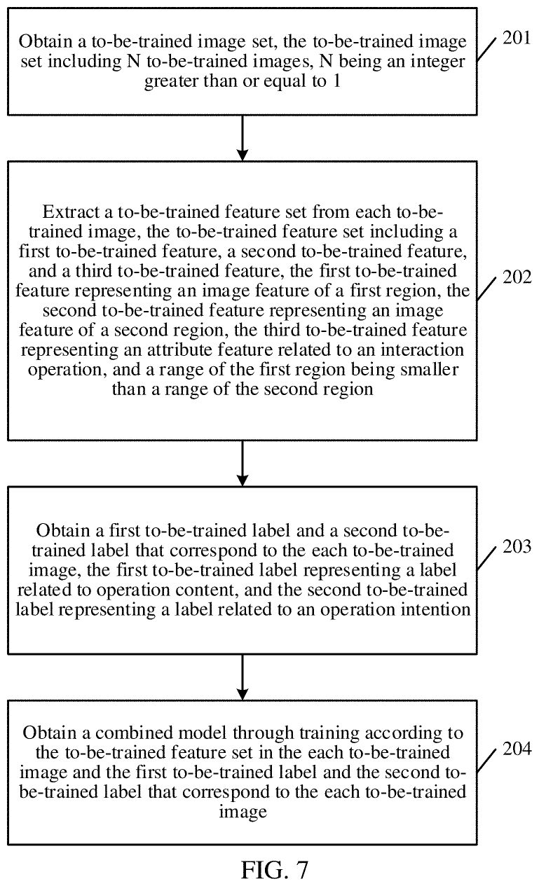

A model prediction method in this application is introduced below, where not only fast supervised learning is performed by using human data, but also prediction accuracy of a model can be improved by using reinforcement learning. Referring to FIG. 7, an embodiment of the model prediction method in the embodiments of this application includes the following steps:

201. Obtain a to-be-trained image set, the to-be-trained image set including N to-be-trained images, N being an integer greater than or equal to 1.

In this embodiment, a process of model training is introduced. The server first obtains a corresponding to-be-trained image set according to human player game data reported by the clients. The to-be-trained image set generally includes a plurality of frames of images. That is, the to-be-trained image set includes N to-be-trained images to improve model precision, N being an integer greater than or equal to 1.

202. Extract a to-be-trained feature set from each to-be-trained image, the to-be-trained feature set including a first to-be-trained feature, a second to-be-trained feature, and a third to-be-trained feature, the first to-be-trained feature representing an image feature of a first region, the second to-be-trained feature representing an image feature of a second region, the third to-be-trained feature representing an attribute feature related to an interaction operation, and a range of the first region being smaller than a range of the second region.

In this embodiment, the server needs to extract a to-be-trained feature set of each to-be-trained image in the to-be-trained image set, and the to-be-trained feature set mainly includes three types of features, respectively, a first to-be-trained feature, a second to-be-trained feature, and a third to-be-trained feature. The first to-be-trained feature represents an image feature of a first region, and for example, the first to-be-trained feature is a minimap image-like feature in the MOBA game. The second to-be-trained feature represents an image feature of a second region, and for example, the second to-be-trained feature is a current visual field image-like feature in the MOBA game. The third to-be-trained feature represents an attribute feature related to an interaction operation. For example, the third to-be-trained feature is a hero attribute vector feature in the MOBA game.

203. Obtain a first to-be-trained label and a second to-be-trained label that correspond to the each to-be-trained image, the first to-be-trained label representing a label related to operation content, and the second to-be-trained label representing a label related to an operation intention.

In this embodiment, the server further needs to obtain a first to-be-trained label and a second to-be-trained label that correspond to the each to-be-trained image. The first to-be-trained label represents a label related to the operation content. For example, the first to-be-trained label is a label related to a micro control task. The second to-be-trained label represents a label related to the operation intention. For example, the second to-be-trained label is a label related to a big picture task.

In an actual application, step 203 may be performed before step 202, or may be performed after step 202, or may be performed simultaneously with step 202. This is not limited herein.

204. Obtain a combined model through training according to the to-be-trained feature set in the each to-be-trained image and the first to-be-trained label and the second to-be-trained label that correspond to the each to-be-trained image. In another implementation, the combined model may be referred as a target combined model.

In this embodiment, the server finally performs training based on the to-be-trained feature set extracted from the each to-be-trained image and the first to-be-trained label and the second to-be-trained label that correspond to the each to-be-trained image, to obtain a combined model. The combined model may be configured to predict a situation of a big picture task and an instruction of a micro control task.

In the embodiments of this application, a model training method is introduced. The server first obtains a to-be-trained image set, and then extracts a to-be-trained feature set from each to-be-trained image, where the to-be-trained feature set includes a first to-be-trained feature, a second to-be-trained feature, and a third to-be-trained feature. The server then needs to obtain a first to-be-trained label and a second to-be-trained label that correspond to the each to-be-trained image, and finally obtains the combined model through training according to the to-be-trained feature set in the each to-be-trained image and the first to-be-trained label and the second to-be-trained label that correspond to the each to-be-trained image. According to the foregoing manners, a model that can predict micro control and a big picture at the same time is designed. Therefore, the big picture model and the micro control model are merged into a combined model, thereby effectively resolving a hard handover problem in a hierarchical model and improving the convenience of prediction. In addition, in consideration of that the big picture task may effectively improve the accuracy of macroscopic decision making, and the big picture decision is quite important in a MOBA game especially.

Optionally, based on the embodiment corresponding to FIG. 7, in a first optional embodiment of the model training method according to an embodiment of this application, the first to-be-trained feature is a two-dimensional vector feature, and the first to-be-trained feature includes at least one of character position information, moving object position information, fixed object position information, and defensive object position information in the first region;

the second to-be-trained feature is a two-dimensional vector feature, and the second to-be-trained feature includes at least one of character position information, moving object position information, fixed object position information, defensive object position information, obstacle object position information, and output object position information in the second region;

the third to-be-trained feature is a one-dimensional vector feature, and the third to-be-trained feature includes at least one of a character hit point value, a character output value, time information, and score information; and

there is a correspondence between the first to-be-trained feature, the second to-be-trained feature, and the third to-be-trained feature.

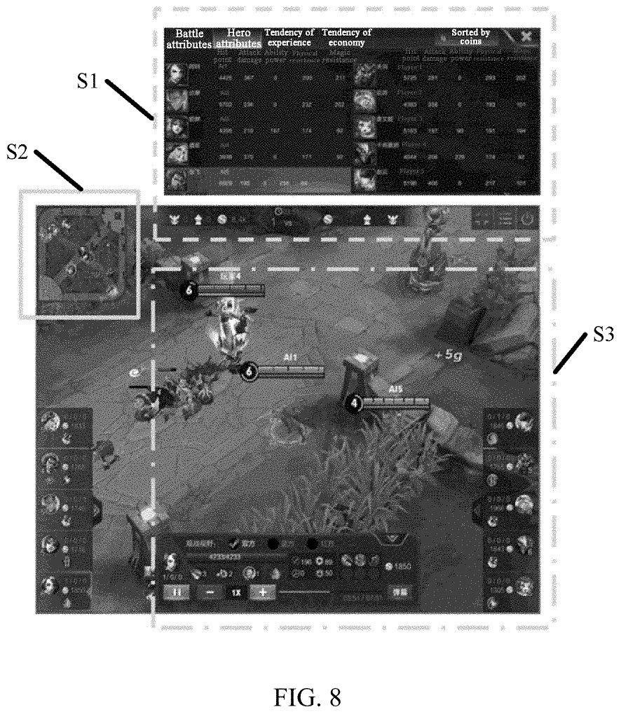

In this embodiment, the relationship between the first to-be-trained feature, the second to-be-trained feature, and the third to-be-trained feature and content thereof are introduced. For ease of introduction, description is made below by using a scene of a MOBA game as an example, where when a human player performs an operation, information, such as a minimap, a current visual field, and hero attributes, is comprehensively considered. Therefore, a multi-modality and multi-scale feature expression is used in this application. Referring to FIG. 8, FIG. 8 is a schematic diagram of an embodiment of extracting a to-be-trained feature set according to an embodiment of this application. As shown in FIG. 8, a part indicated by S1 is hero attribute information, including hero characters in the game, and a hit point value, an attack damage value, an ability power value, an attack defense value, and a magic defense value of each hero character. A part indicated by S2 is a minimap, that is, the first region. In the minimap, positions of, for example, a hero character, a minion line, a monster, and a turret can be seen. The hero character includes a hero character controlled by a teammate and a hero character controlled by an opponent. The minion line refers to a position at which minions of both sides battle with each other. The monster refers to a “neutral and hostile” object other than players in an environment, is a non-player character (NPC) monster, and is not controlled by a player. The turret refers to a defensive structure. The two camps each have a Nexus turret, and one camp who destroys the Nexus turret of the opponent wins. A part indicated by S3 is a current visual field, that is, the second region. In the current visual field, heroes, minion lines, monsters, turrets, map obstacles, and bullets can be clearly seen.

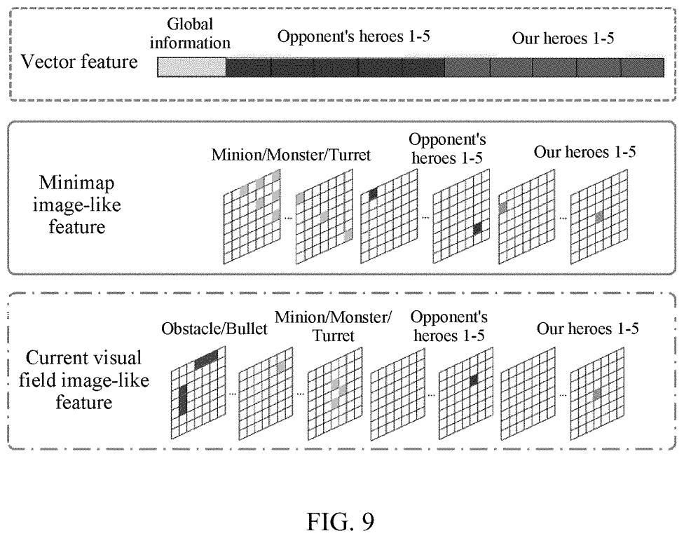

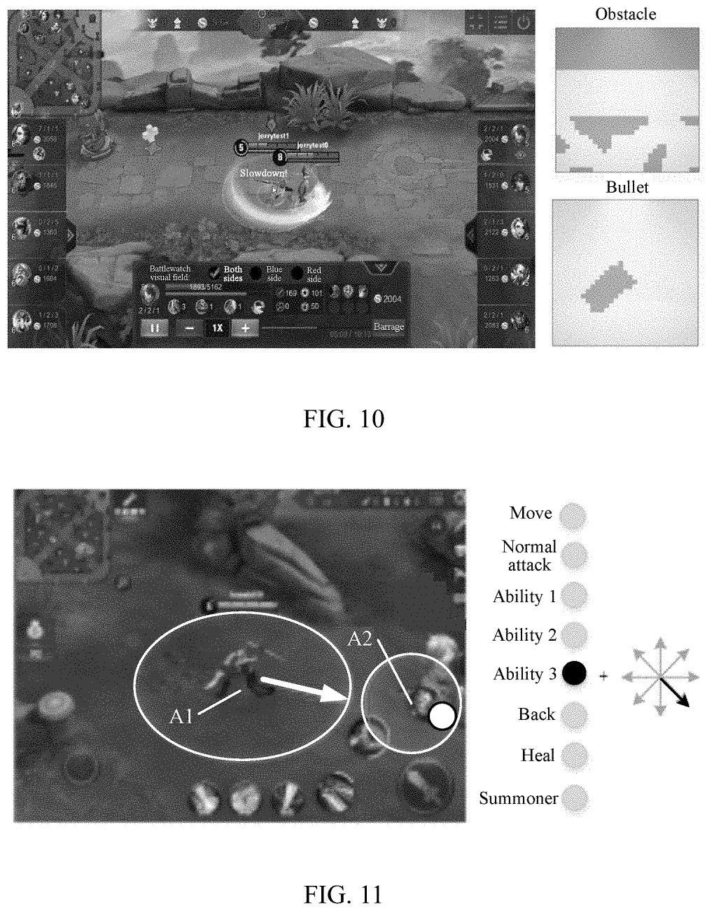

Referring to FIG. 9, FIG. 9 is a schematic diagram of a feature expression of a to-be-trained feature set according to an embodiment of this application. As shown in FIG. 9, a one-to-one mapping relationship between a hero attribute vector feature (that is, the third to-be-trained feature) and a current visual field image-like feature (that is, the second to-be-trained feature) is established through a minimap image-like feature (that is, the first to-be-trained feature), and can be used in both macroscopic decision making and microcosmic decision making. The hero attribute vector feature is a feature formed by values, and therefore, is a one-dimensional vector feature. The vector feature includes, but is not limited to, attribute features of hero characters, for example hit points (that is, the hit point values of the opponent's five hero characters and the hit point values of five our hero characters), attack powers (that is, character output values of the five opponent's hero characters and character output values of the five our hero characters), a time (a duration of a round of game), and a score (a final score of each team). Both the minimap image-like feature and the current visual field image-like feature are image-like features. For ease of understanding, referring to FIG. 10, FIG. 10 is a schematic diagram of an image-like feature expression according to an embodiment of this application. As shown in FIG. 10, an image-like feature is a two-dimensional feature manually constructed from an original pixel image, so that the difficulty of directly learning the original complex image is reduced. The minimap image-like feature includes position information of heroes, minion lines, monsters, turrets, and the like, and is used for representing macroscopic-scale information. The current visual field image-like feature includes position information of heroes, minion lines, monsters, turrets, map obstacles, and bullets, and is used for representing local microscopic-scale information.

Such a multi-modality and multi-scale feature simulating a human viewing angle not only can model a spatial relative position relationship better, but also is quite suitable for an expression of a feature in a high-dimensional state in the MOBA game.

In the embodiments of this application, content of the three to-be-trained features is also introduced, where the first to-be-trained feature is a two-dimensional vector feature, the second to-be-trained feature is a two-dimensional vector feature, and the third to-be-trained feature is a one-dimensional vector feature. According to the foregoing manners, on one hand, specific information included in the three to-be-trained features may be determined, and more information is therefore obtained for model training. On the other hand, both the first to-be-trained feature and the second to-be-trained feature are two-dimensional vector features, which helps to improve a spatial expression of the feature, thereby improving diversity of the feature.

Optionally, based on the embodiment corresponding to FIG. 7, in a second optional embodiment of the model training method according to the embodiments of this application, the first to-be-trained label includes key type information and/or key parameter information; and the key parameter information includes at least one of a direction-type parameter, a position-type parameter, and a target-type parameter, the direction-type parameter being used for representing a moving direction of a character, the position-type parameter being used for representing a position of the character, and the target-type parameter being used for representing a to-be-targeted object of the character. In another implementation, the to-be-targeted object of the character may be referred as a to-be-outputted object of the character.

In this embodiment, content included by the first to-be-trained label is introduced in detail. The first to-be-trained label includes key type information and/or key parameter information. Generally, using both the key type information and the key parameter information as the first to-be-trained label is considered, to improve accuracy of the label. When a human player performs an operation, the human player generally first determines a key to use and then determines an operation parameter of the key. Therefore, in this application, a hierarchical label design is used. That is, a key is to be executed at a current moment is predicted first, and a release parameter of the key is then predicted.

For ease of understanding, the following introduces the first to-be-trained label by using examples with reference to the accompanying drawings. The key parameter information is mainly divided into three type of information, respectively, direction-type information, position-type information, and target-type information. A direction of a circle is 360 degrees. Assuming that a label is set every 6 degrees, the direction-type information may be discretized into 60 directions. One hero character generally occupies 1000 pixels in an image, so that the position-type information may be discretized into 30×30 positions. In addition, the target-type information is represented as a candidate attack target, which may be an object that is attacked when the hero character casts an ability.

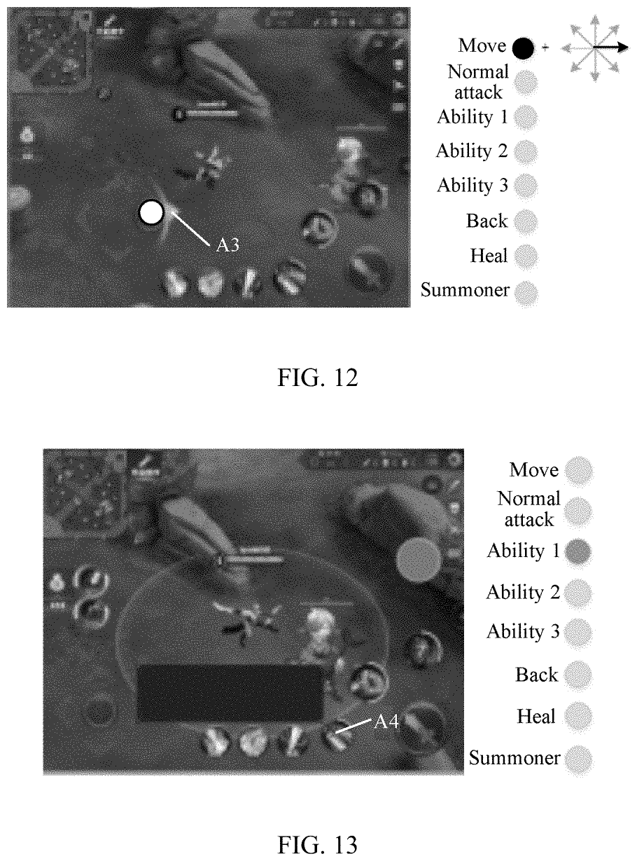

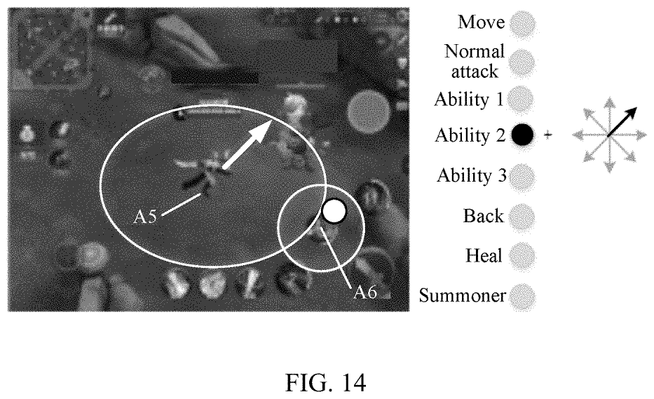

Referring to FIG. 11, FIG. 11 is a schematic diagram of a micro control label according to an embodiment of this application. As shown in FIG. 11, a hero character casts an ability 3 within a range shown by A1, and an ability direction is a 45-degree direction at the bottom right. A2 indicates a position of the ability 3 in an operation interface. Therefore, the operation of the human player is represented as “ability 3+direction”. Referring to FIG. 12, FIG. 12 is another schematic diagram of a micro control label according to an embodiment of this application. As shown in FIG. 12, the hero character moves along a direction shown by A3, and a moving direction is the right. Therefore, the operation of the human player is represented as “move+direction”. Referring to FIG. 13, FIG. 13 is another schematic diagram of a micro control label according to an embodiment of this application. As shown in FIG. 13, the hero character casts an ability 1, and A4 indicates a position of the ability 1 in an operation interface. Therefore, the operation of the human player is represented as “ability 1”. Referring to FIG. 14, FIG. 14 is another schematic diagram of a micro control label according to an embodiment of this application. As shown in FIG. 14, a hero character casts an ability 2 within a range shown by A5, and an ability direction is a 45-degree direction at the top right. A6 indicates a position of the ability 2 in an operation interface. Therefore, the operation of the human player is represented as “ability 2+direction”.

AI may predict abilities of different cast types, that is, predict a direction for a direction-type key, predict a position for a position-type key, and predict a specific target for a target-type key. A hierarchical label design method is closer to a real operation intention of the human player in a game process, which is more helpful for AI learning.

In the embodiments of this application, it is described that the first to-be-trained label includes the key type information and/or the key parameter information, where the key parameter information includes at least one of a direction-type parameter, a position-type parameter, and a target-type parameter, the direction-type parameter being used for representing a moving direction of a character, the position-type parameter being used for representing a position of the character, and the target-type parameter being used for representing a to-be-targeted object of the character. According to the foregoing manners, content of the first to-be-trained label is further refined, and labels are established in a hierarchical manner, which may be closer to the real operation intention of the human player in the game process, thereby helping to improve a learning capability of AI.

Optionally, based on the embodiment corresponding to FIG. 7, in a third optional embodiment of the model training method according to the embodiments of this application, the second to-be-trained label includes operation intention information and character position information; and

the operation intention information represents an intention with which a character interacts with an object, and the character position information represents a position of the character in the first region.

In this embodiment, content included by the second to-be-trained label is introduced in detail, and the second to-be-trained label includes the operation intention information and the character position information. In an actual application, the human player performs big picture decisions according to a current game state, for example, farming a minion line in the top lane, killing monsters in our jungle, participating in a teamfight in the middle lane, and pushing a turret in the bottom lane. The big picture decisions are different from micro control that has specific operation keys corresponding thereto, and instead, are reflected in player data as an implicit intention.

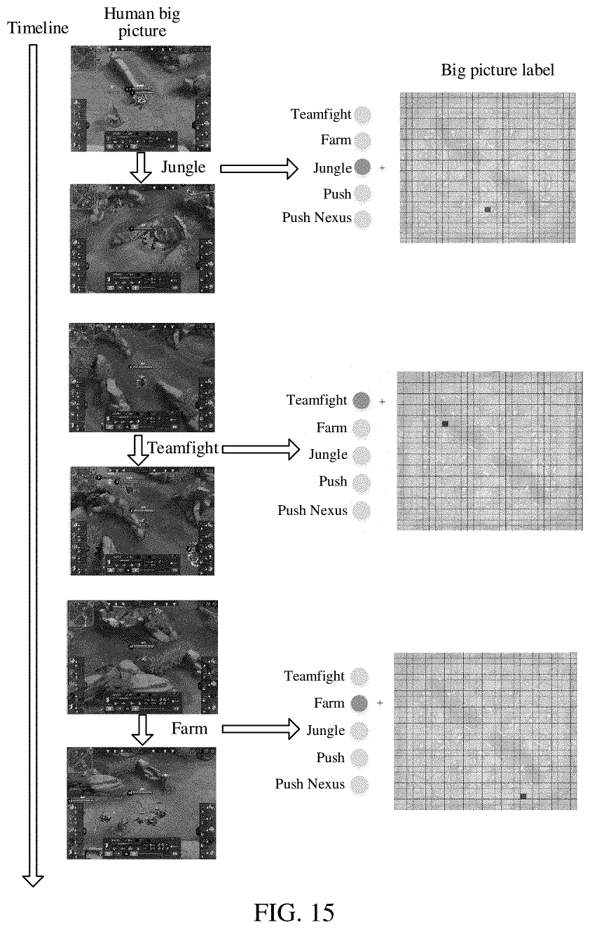

For ease of understanding, referring to FIG. 15, FIG. 15 is a schematic diagram of a big picture label according to an embodiment of this application. For example, a human big picture and a corresponding big picture label (the second to-be-trained label) are obtained according to a change of a timeline. A video of a round of battle of a human player may be divided into scenes such as “teamfight”, “farm”, “jungle”, and “push”, and operation intention information of a big picture intention of the player may be expressed by modeling the scenes. The minimap is discretized into 24*24 blocks, and the character position information represents a block in which a character is located during a next attack. As shown in FIG. 15, the second to-be-trained label is operation intention information+character position information, which is represented as “jungle+coordinates A”, “teamfight+coordinates B”, and “farm+coordinates C” respectively.

In the embodiments of this application, it is described that the second to-be-trained label includes the operation intention information and the character position information, where the operation intention information represents an intention with which a character interacts with an object, and the character position information represents a position of the character in the first region. According to the foregoing manners, the big picture of the human player is reflected by the operation intention information and the character position information jointly. In a MOBA game, a big picture decision is quite important, so that feasibility and operability of the solution are improved.

Optionally, based on the embodiment corresponding to FIG. 7, in a fourth optional embodiment of the model training method according to the embodiments of this application, the obtaining a combined model through training according to the to-be-trained feature set in the each to-be-trained image and the first to-be-trained label and the second to-be-trained label that correspond to the each to-be-trained image may include the following steps:

processing the to-be-trained feature set in the each to-be-trained image to obtain a target feature set, the target feature set including a first target feature, a second target feature, and a third target feature;

obtaining a first predicted label and a second predicted label that correspond to the target feature set by using an LSTM layer, the first predicted label representing a label that is obtained through prediction and that is related to the operation content, and the second predicted label representing a label that is obtained through prediction and that is related to the operation intention;

obtaining a model core parameter through training according to the first predicted label, the first to-be-trained label, the second predicted label, and the second to-be-trained label of the each to-be-trained image, both the first predicted label and the second predicted label being predicted values, and both the first to-be-trained label and the second to-be-trained label being true values; and

generating the combined model according to the model core parameter.

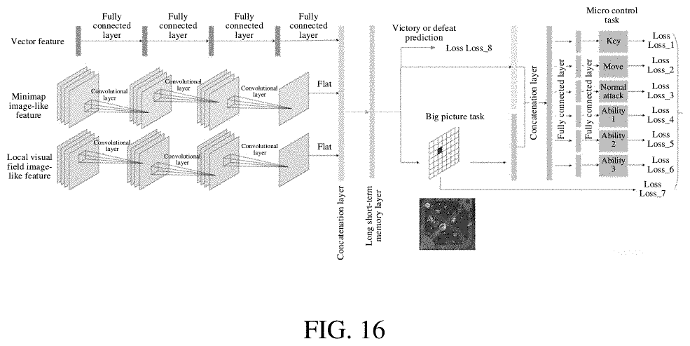

In this embodiment, a general process of obtaining the combined model through training is introduced. For ease of understanding, referring to FIG. 16, FIG. 16 is a schematic diagram of a network structure of a combined model according to an embodiment of this application. As shown in FIG. 16, input of a model is a to-be-trained feature set of a current frame of to-be-trained image, and the to-be-trained feature set includes a minimap image-like feature (the first to-be-trained feature), a current visual field image-like feature (the second to-be-trained feature), and a hero character vector feature (the third to-be-trained feature). The image-like features are encoded through a convolutional network respectively, and the vector feature is encoded through a fully connected network, to obtain a target feature set. The target feature set includes a first target feature, a second target feature, and a third target feature. The first target feature is obtained after the first to-be-trained feature is processed, the second target feature is obtained after the second to-be-trained feature is processed, and the third target feature is obtained after the third to-be-trained feature is processed. The target feature set then forms a public encoding layer through concatenation. The encoding layer is inputted into an LSTM network layer, and the LSTM network layer is mainly used for resolving a problem of partial visibility of a visual field of a hero.

An LSTM network is a time recurrent neural network and is suitable for processing and predicting an important event with a relatively long interval and latency in time series. T LSTM differs from a recurrent neural network (RNN) mainly in that a processor configured to determine whether information is useful is added to an algorithm, and a structure in which the processor works is referred to as a unit. Three gates are placed into one unit, and are respectively referred to as an input gate, a forget gate, and an output gate. When a piece of information enters the LSTM network layer, whether the information is useful may be determined according to a rule, only information that succeeds in algorithm authentication is retained, and information that fails in algorithm authentication is forgotten through the forget gate The LSTM is an effective technology to resolve a long-sequence dependency problem and has quite high universality. For a MOBA game, there may be a problem of an invisible visual field. That is, a hero character on our side may only observe opponent's heroes, monsters, and minion lines around our units (for example, hero characters of teammates), and cannot observe an opponent's unit at another position, and an opponent's hero may shield oneself from a visual field by hiding in a bush or using a stealth ability. In this way, information integrity is considered in a process of model training, so that hidden information needs to be restored by using the LSTM network layer.

A first predicted label and a second predicted label of the frame of to-be-trained image may be obtained based on an output result of the LSTM layer. A first to-be-trained label and a second to-be-trained label of the frame of to-be-trained image are determined according to a manually labeled result. In this case, a minimum value between the first predicted label and the first to-be-trained label can be obtained by using a loss function, and a minimum value between the second predicted label and the second to-be-trained label is obtained by using the loss function, and a model core parameter is determined based on the minimum values. The model core parameter includes model parameters under micro control tasks (for example, key, move, normal attack, ability 1, ability 2, and ability 3) and model parameters under big picture tasks. The combined model is generated according to the model core parameter.

It may be understood that each output task may be calculated independently, that is, a fully connected network parameter of an output layer of each task is only subject to impact of the task. The combined model includes secondary tasks used for predicting a big picture position and an intention, and output of the big picture task is outputted to an encoding layer of a micro control task in a cascaded form.

The loss function is used for estimating an inconsistency degree between a predicted value and a true value of a model and is a non-negative real-valued function. A smaller loss function indicates greater robustness of the model. The loss function is a core part of an empirical risk function and also an important component of a structural risk function. Common loss functions include, but are not limited to, a hinge loss, a cross entropy loss, a square loss, and an exponential loss.

In the embodiments of this application, a process of obtaining the combined model through training is provided, and the process mainly includes processing the to-be-trained feature set of the each to-be-trained image to obtain the target feature set. The first predicted label and the second predicted label that correspond to the target feature set are then obtained by using the LSTM layer, and the model core parameter is obtained through training according to the first predicted label, the first to-be-trained label, the second predicted label, and the second to-be-trained label of the each to-be-trained image. The model core parameter is used for generating the combined model. According to the foregoing manners, a problem that some visual fields are unobservable may be resolved by using the LSTM layer. That is, the LSTM layer may obtain data within a previous period of time, so that the data may be more complete, which helps to make inference and decision in the process of model training.

Optionally, based on the fourth embodiment corresponding to FIG. 7, in a fifth optional embodiment of the model training method according to the embodiments of this application, the processing the to-be-trained feature set in the each to-be-trained image to obtain a target feature set may include the following steps: processing the third to-be-trained feature in the each to-be-trained image by using an FC layer to obtain a third target feature, the third target feature being a one-dimensional vector feature; processing the second to-be-trained feature in the each to-be-trained image by using a convolutional layer to obtain a second target feature, the second target feature being a one-dimensional vector feature; and processing the first to-be-trained feature in the each to-be-trained image by using the convolutional layer to obtain a first target feature, the first target feature being a one-dimensional vector feature.

In this embodiment, how to process the to-be-trained feature set of each frame of to-be-trained image that is inputted by the model is introduced. The to-be-trained feature set includes a minimap image-like feature (the first to-be-trained feature), a current visual field image-like feature (the second to-be-trained feature), and a hero character vector feature (the third to-be-trained feature). For example, a processing manner for the third to-be-trained feature is to input the third to-be-trained feature into the FC layer and obtain the third target feature outputted by the FC layer. A function of the FC layer is to map a distributed feature expression to a sample labeling space. Each node of the FC layer is connected to all nodes of a previous layer to integrate the previously extracted features. Due to the characteristic of being fully connected, usually, a number of parameters of the FC layer is the greatest.

A processing manner for the first to-be-trained feature and the second to-be-trained feature is to output the two features into the convolutional layer respectively, to output the first target feature corresponding to the first to-be-trained feature and the second target feature corresponding to the second to-be-trained feature by using the convolutional layer. An original image may be flattened by using the convolutional layer. For image data, one pixel is greatly related to data in directions, such as upward, downward, leftward, and rightward directions, of the pixel, and during full connection, after data is unfolded, correlation of images is easily ignored, or two irrelevant pixels are forcibly associated. Therefore, convolution processing needs to be performed on the image data. Assuming that image pixels corresponding to the first to-be-trained feature are 10×10, the first target feature obtained through the convolutional layer is a 100-dimensional vector feature. Assuming that image pixels corresponding to the second to-be-trained feature are 10×10, the second target feature obtained through the convolutional layer is a 100-dimensional vector feature. Assuming that the third target feature corresponding to the third to-be-trained feature is a 10-dimensional vector feature, a 210 (100+100+10)-dimensional vector feature may be obtained through a concatenation (concat) layer.

In the embodiments of this application, the to-be-trained feature set may be further processed. That is, the first to-be-trained feature in the each to-be-trained image is processed by using the FC layer to obtain the first target feature. The second to-be-trained feature in the each to-be-trained image is processed by using the convolutional layer to obtain the second target feature. The third to-be-trained feature in the each to-be-trained image is processed by using the convolutional layer to obtain the third target feature. According to the foregoing manners, one-dimensional vector features may be obtained, and concatenation processing may be performed on the vector features for subsequent model training, thereby helping to improve feasibility and operability of the solution.

Optionally, based on the fourth embodiment corresponding to FIG. 7, in a sixth optional embodiment of the model training method according to the embodiments of this application, the obtaining a first predicted label and a second predicted label that correspond to the target feature set by using an LSTM layer may include:

obtaining a first predicted label, a second predicted label, and a third predicted label that correspond to the target feature set by using the LSTM layer, the third predicted label representing a label that is obtained through prediction and that is related to a victory or a defeat; and

the obtaining a model core parameter through training according to the first predicted label, the first to-be-trained label, the second predicted label, and the second to-be-trained label of the each to-be-trained image includes:

obtaining a third to-be-trained label corresponding to the each to-be-trained image, the third to-be-trained label being used for representing an actual victory or defeat; and

obtaining the model core parameter through training according to the first predicted label, the first to-be-trained label, the second predicted label, the second to-be-trained label, the third predicted label, and the third to-be-trained label, wherein the third to-be-trained label is a true value, and the third predicted label is a predicated value.

In this embodiment, it is further introduced that the combined model may further predict a victory or a defeat. For example, based on the fourth embodiment corresponding to FIG. 7, a third to-be-trained label of the frame of to-be-trained image may be obtained based on an output result of the LSTM layer. The third to-be-trained label of the frame of to-be-trained image is determined according to a manually labeled result. In this case, a minimum value between the third predicted label and the third to-be-trained label may be obtained by using a loss function, and the model core parameter is determined based on the minimum value. In this case, the model core parameter not only includes model parameters under micro control tasks (for example, key, move, normal attack, ability 1, ability 2, and ability 3) and model parameters under big picture tasks, but also includes model parameters under showdown tasks, and the combined model is finally generated according to the model core parameter.

In the embodiments of this application, it is described that the combined model may further train a label related to victory or defeat. That is, the server obtains, by using the LSTM layer, the first predicted label, the second predicted label, and the third predicted label that correspond to the target feature set, where the third predicted label represents a label that is obtained through prediction and that is related to a victory or a defeat. Then the server obtains the third to-be-trained label corresponding to the each to-be-trained image, and finally obtains the model core parameter through training according to the first predicted label, the first to-be-trained label, the second predicted label, the second to-be-trained label, the third predicted label, and the third to-be-trained label. According to the foregoing manners, the combined model may further predict a winning percentage of a match. Therefore, awareness and learning of a situation may be reinforced, thereby improving reliability and diversity of model application.

Optionally, based on any one of FIG. 7 and the first embodiment to the sixth embodiment corresponding to FIG. 7, in a seventh optional embodiment of the model training method according to the embodiments of this application, after the obtaining a combined model through training according to the to-be-trained feature set in the each to-be-trained image and the first to-be-trained label and the second to-be-trained label that correspond to the each to-be-trained image, the method may further include:

obtaining a to-be-trained video, the to-be-trained video including a plurality of frames of interaction images;

obtaining target scene data corresponding to the to-be-trained video by using the combined model, the target scene data including related data in a target scene;

obtaining a target model parameter through training according to the target scene data, the first to-be-trained label, and the first predicted label, the first predicted label representing a label that is obtained through prediction and that is related to the operation content, the first predicted label being a predicted value, and the first to-be-trained label being a true value; and

updating the combined model by using the target model parameter, to obtain a reinforced combined model.

In this embodiment, because there are a large number of MOBA game players, a large amount of human player data may be generally used for supervised learning and training, thereby simulating human operations by using the model. However, there may be a misoperation due to various factors such as nervousness or inattention of a human. The misoperation may include a deviation in an ability casting direction or not dodging an opponent's ability in time, leading to existence of a bad sample in training data. In view of this, this application may optimize some task layers in the combined model through reinforcement learning. For example, reinforcement learning is only performed on the micro control FC layer and not performed on the big picture FC layer.

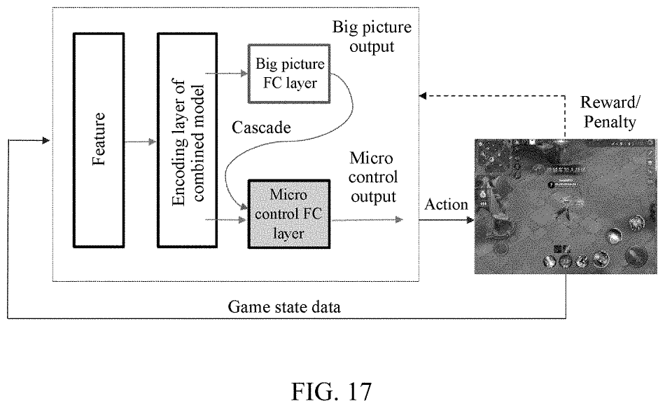

For ease of understanding, referring to FIG. 17, FIG. 17 is a schematic diagram of a system structure of a reinforced combined model according to an embodiment of this application. As shown in FIG. 17, the combined model includes a combined model, a big picture FC layer, and a micro control FC layer. An encoding layer in the combined model and the big picture FC layer have obtained corresponding core model parameters through supervised learning. In a process of reinforcement learning, the core model parameters in the encoding layer in the combined model and the big picture FC layer are maintained unchanged. Therefore, the feature expression does not need to be learned during reinforcement learning, thereby accelerating convergence of reinforcement learning. A number of steps of decisions of a micro control task in a teamfight scene is 100 on average (approximately 20 seconds), and the number of steps of decisions can be effectively reduced. Key capabilities, such as the ability hit rate and dodging an opponent's ability, of AI can be improved by reinforcing the micro control FC layer. The micro control FC layer performs training by using a reinforcement learning algorithm, and the algorithm may be specifically a proximal policy optimization (PPO) algorithm.

The following introduces a process of reinforcement learning:

Step 1. After the combined model is obtained through training, the server may load the combined model obtained through supervised learning, fix the encoding layer of the combined model and the big picture FC layer, and needs to load a game environment.

Step 2. Obtain a to-be-trained video. The to-be-trained video includes a plurality of frames of interaction images. A battle is performed from a start frame in the to-be-trained video by using the combined model, and target scene data of a hero teamfight scene is stored. The target scene data may include features, actions, a reward signal, and probability distribution outputted by a combined model network. The features are the hero attribute vector feature, the minimap image-like feature, and the current visual field image-like feature. The actions are keys used by the player during controlling a hero character. The reward signal is a number of times that a hero character kill opponent's hero characters in a teamfight process. The probability distribution outputted by the combined model network may be represented as a distribution probability of each label in a micro control task. For example, a distribution probability of a label 1 is 0.1, a distribution probability of a label 2 is 0.3, and a distribution probability of a label 3 is 0.6.

Step 3. Obtain a target model parameter through training according to the target scene data, the first to-be-trained label, and the first predicted label, and update the core model parameters in the combined model by using the PPO algorithm. Only the model parameter of the micro control FC layer is updated. That is, an updated model parameter is generated according to the first to-be-trained label and the first predicted label. Both the first to-be-trained label and the first predicted label are labels related to the micro control task.

Step 4. If a maximum number of frames of iterations is not reached after the processing of step 2 to step 4 is performed on each frame of image in the to-be-trained video, send the updated combined model to a gaming environment and return to step 2. Step 5 is performed if the maximum number of frames of iterations is reached. The maximum number of frames of iterations may be set based on experience, or may be set based on scenes. This is not limited in the embodiments of this application. In another implementation, the step 4 may include determining whether a number of frames that are processed in steps 2-3 is larger than or equal to a maximum number; in response to the determining that the number of frames that are processed in steps 2-3 is larger than or equal to the maximum number, performing step 5; and in response to the determining that the number of frames that are processed in steps 2-3 is not larger than or equal to the maximum number, sending the updated combined model to a gaming environment and returning to step 2.

Step 5. Save a reinforced combined model finally obtained after reinforcement.

Further, in the embodiments of this application, some task layers in the combined model may be further optimized through reinforcement learning, and if a part of the micro control task needs to be reinforced, the server obtains the to-be-trained video. The server then obtains the target scene data corresponding to the to-be-trained video by using the combined model, and obtains the target model parameter through training based on the target scene data, the first to-be-trained label, and the first predicted label. Finally, the server updates the combined model by using the target model parameter to obtain the reinforced combined model. According to the foregoing manners, AI capabilities may be improved by reinforcing the micro control FC layer. In addition, reinforcement learning may further overcome misoperation problems caused by various factors such as nervousness or inattention of a human, thereby greatly reducing a number of bad samples in training data, and further improving reliability of the model and accuracy of performing prediction by using the model. The reinforcement learning method may only reinforce some scenes, to reduce the number of steps of a decision and accelerate convergence.

Optionally, based on any one of FIG. 7 and the first embodiment to the sixth embodiment corresponding to FIG. 7, in an eighth optional embodiment of the model training method according to the embodiments of this application, after the obtaining a combined model through training according to the to-be-trained feature set in the each to-be-trained image and the first to-be-trained label and the second to-be-trained label that correspond to the each to-be-trained image, the method may further include:

obtaining a to-be-trained video, the to-be-trained video including a plurality of frames of interaction images;

obtaining target scene data corresponding to the to-be-trained video by using the combined model, the target scene data including related data in a target scene;

obtaining a target model parameter through training according to the target scene data, the second to-be-trained label, and the second predicted label, the second predicted label representing a label that is obtained through prediction and that is related to the operation intention, the second predicted label being a predicted value, and the second to-be-trained label being a true value; and

updating the combined model by using the target model parameter, to obtain a reinforced combined model.

In this embodiment, because there are a large number of MOBA game players, a large amount of human player data may be generally used for supervised learning and training, thereby simulating human operations by using the model. However, there may be a misoperation due to various factors such as nervousness or inattention of a human. The misoperation may include a deviation in an ability casting direction or not dodging an opponent's ability in time, leading to existence of a bad sample in training data. In view of this, this application may optimize some task layers in the combined model through reinforcement learning. For example, reinforcement learning is only performed on the big picture FC layer and not performed on the micro control FC layer.

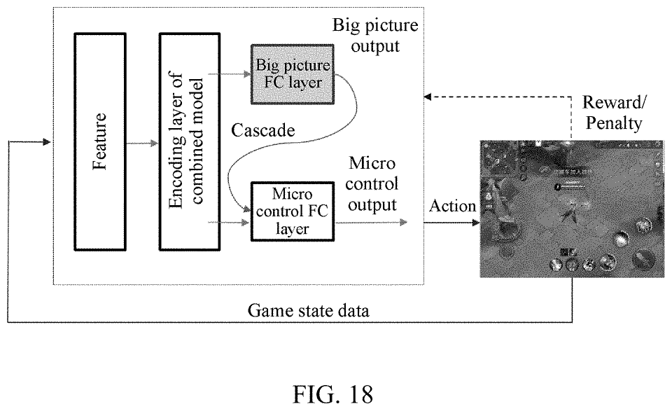

For ease of understanding, referring to FIG. 18, FIG. 18 is another schematic diagram of a system structure of a reinforced combined model according to an embodiment of this application. As shown in FIG. 18, the combined model includes a combined model, a big picture FC layer, and a micro control FC layer. An encoding layer in the combined model and the micro control FC layer have obtained corresponding core model parameters through supervised learning. In a process of reinforcement learning, the core model parameters in the encoding layer in the combined model and the micro control FC layer are maintained unchanged. Therefore, the feature expression does not need to be learned during reinforcement learning, thereby accelerating convergence of reinforcement learning. A macroscopic decision-making capability of AI may be improved by reinforcing the big picture FC layer. The big picture FC layer performs training by using a reinforcement learning algorithm, and the algorithm may be the PPO algorithm or an Actor-Critic algorithm.

The following introduces a process of reinforcement learning:

Step 1. After the combined model is obtained through training, the server may load the combined model obtained through supervised learning, fix the encoding layer of the combined model and the micro control FC layer, and needs to load a game environment.

Step 2. Obtain a to-be-trained video. The to-be-trained video includes a plurality of frames of interaction images. A battle is performed from a start frame in the to-be-trained video by using the combined model, and target scene data of a hero teamfight scene is stored. The target scene data may include data in scenes such as “jungle”, “farm”, “teamfight”, and “push”.

Step 3. Obtain a target model parameter through training according to the target scene data, the second to-be-trained label, and the second predicted label, and update the core model parameters in the combined model by using the Actor-Critic algorithm. Only the model parameter of the big picture FC layer is updated. That is, an updated model parameter is generated according to the second to-be-trained label and the second predicted label. Both the second to-be-trained label and the second predicted label are labels related to a big picture task.

Step 4. If a maximum number of frames of iterations is not reached after the processing of step 2 to step 4 is performed on each frame of image in the to-be-trained video, send the updated combined model to a gaming environment and return to step 2. Step 5 is performed if the maximum number of frames of iterations is reached. In another implementation, the step 4 may include determining whether a number of frames in the to-be-trained video that are processed in steps 2-3 is larger than or equal to a maximum number; in response to the determining that the number of frames in the to-be-trained video that are processed in steps 2-3 is larger than or equal to the maximum number, performing step 5; and in response to the determining that the number of frames in the to-be-trained video that are processed in steps 2-3 is not larger than or equal to the maximum number, sending the updated combined model to a gaming environment and returning to step 2.

Step 5. Save a reinforced combined model finally obtained after reinforcement.

Further, in the embodiments of this application, some task layers in the combined model may be further optimized through reinforcement learning, and if a part of the big-picture task needs to be reinforced, the server obtains the to-be-trained video. The server then obtains the target scene data corresponding to the to-be-trained video by using the combined model, and obtains the target model parameter through training based on the target scene data, the second to-be-trained label, and the second predicted label. Finally, the server updates the combined model by using the target model parameter to obtain the reinforced combined model. AI capabilities may be improved by reinforcing the big picture FC layer according to the foregoing manners. In addition, reinforcement learning may further overcome misoperation problems caused by various factors such as nervousness or inattention of a human, thereby greatly reducing a number of bad samples in training data, and further improving reliability of the model and accuracy of performing prediction by using the model. The reinforcement learning method may only reinforce some scenes, to reduce the number of steps of a decision and accelerate convergence.

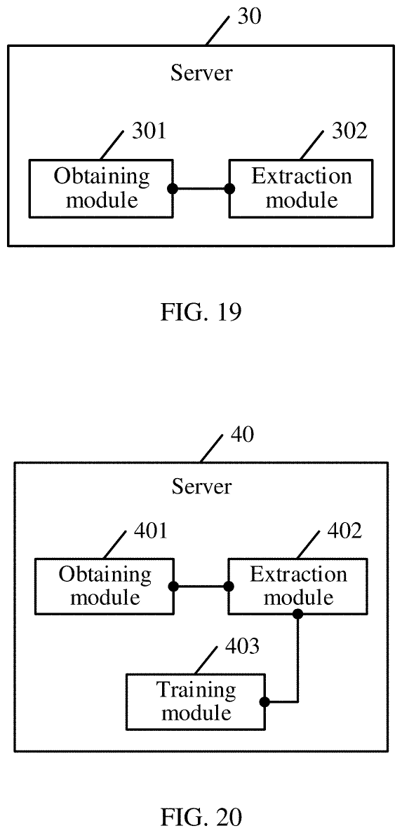

The following describes a server in this application in detail. Referring to FIG. 19, FIG. 19 is a schematic diagram of an embodiment of a server according to an embodiment of this application, and the server 30 includes:

an obtaining module 301, configured to obtain a to-be-predicted image;

an extraction module 302, configured to extract a to-be-predicted feature set from the to-be-predicted image obtained by the obtaining module 301, the to-be-predicted feature set including a first to-be-predicted feature, a second to-be-predicted feature, and a third to-be-predicted feature, the first to-be-predicted feature representing an image feature of a first region, the second to-be-predicted feature representing an image feature of a second region, the third to-be-predicted feature representing an attribute feature related to an interaction operation, and a range of the first region being smaller than a range of the second region; and

the obtaining module 301 being further configured to obtain, by using a combined model, a first label and a second label that correspond to the to-be-predicted feature set extracted by the extraction module 302, the first label representing a label related to operation content, and the second label representing a label related to an operation intention.

In the present disclosure, a module may refer to a software module, a hardware module, or a combination thereof. A software module may include a computer program or part of the computer program that has a predefined function and works together with other related parts to achieve a predefined goal, such as those functions described in this disclosure. A hardware module may be implemented using processing circuitry and/or memory configured to perform the functions described in this disclosure. Each module can be implemented using one or more processors (or processors and memory). Likewise, a processor (or processors and memory) can be used to implement one or more modules. Moreover, each module can be part of an overall module that includes the functionalities of the module. The description here also applies to the term unit and other equivalent terms.

In this embodiment, the obtaining module 301 obtains a to-be-predicted image, and the extraction module 302 extracts a to-be-predicted feature set from the to-be-predicted image obtained by the obtaining module 301. The to-be-predicted feature set includes a first to-be-predicted feature, a second to-be-predicted feature, and a third to-be-predicted feature, the first to-be-predicted feature represents an image feature of a first region, the second to-be-predicted feature represents an image feature of a second region, the third to-be-predicted feature represents an attribute feature related to an interaction operation, and a range of the first region is smaller than a range of the second region. The obtaining module 301 obtains, by using a combined model, a first label and a second label that correspond to the to-be-predicted feature set extracted by the extraction module 302. The first label represents a label related to operation content, and the second label represents a label related to an operation intention.

In the embodiments of this application, a server is provided. The server first obtains a to-be-predicted image, and then extracts a to-be-predicted feature set from the to-be-predicted image. The to-be-predicted feature set includes a first to-be-predicted feature, a second to-be-predicted feature, and a third to-be-predicted feature, the first to-be-predicted feature represents an image feature of a first region, the second to-be-predicted feature represents an image feature of a second region, the third to-be-predicted feature represents an attribute feature related to an interaction operation, and a range of the first region is smaller than a range of the second region. Finally, the server may obtain, by using a combined model, a first label and a second label that correspond to the to-be-predicted image. The first label represents a label related to operation content, and the second label represents a label related to an operation intention. According to the foregoing manners, micro control and a big picture may be predicted by using only one combined model, where a prediction result of the micro control is represented as the first label, and a prediction result of the big picture is represented as the second label. Therefore, the big picture model and the micro control model are merged into a combined model, thereby effectively resolving a hard handover problem in a hierarchical model and improving the convenience of prediction.

Optionally, based on the embodiment corresponding to FIG. 19, in another embodiment of the server 30 according to an embodiment of this application, the obtaining module 301 is configured to obtain, by using the combined model, the first label, the second label, and a third label that correspond to the to-be-predicted feature set. The third label represents a label related to a victory or a defeat.

In the embodiments of this application, the combined model not only can output the first label and the second label, but also can further output the third label, that is, the combined model may further predict a victory or a defeat. According to the foregoing manners, in an actual application, a result of a situation may be better predicted, which helps to improve the reliability of prediction and improve the flexibility and practicability of prediction.

The following describes a server in this application in detail. Referring to FIG. 20, FIG. 20 is a schematic diagram of an embodiment of a server according to an embodiment of this application, and the server 40 includes:

an obtaining module 401, configured to obtain a to-be-trained image set, the to-be-trained image set including N to-be-trained images, N being an integer greater than or equal to 1;

an extraction module 402, configured to extract a to-be-trained feature set from each to-be-trained image obtained by the obtaining module 401, the to-be-trained feature set including a first to-be-trained feature, a second to-be-trained feature, and a third to-be-trained feature, the first to-be-trained feature representing an image feature of a first region, the second to-be-trained feature representing an image feature of a second region, the third to-be-trained feature representing an attribute feature related to an interaction operation, and a range of the first region being smaller than a range of the second region;

the obtaining module 401 being configured to obtain a first to-be-trained label and a second to-be-trained label that correspond to the each to-be-trained image, the first to-be-trained label representing a label related to operation content, and the second to-be-trained label representing a label related to an operation intention; and

a training module 403, configured to obtain a combined model through training according to the to-be-trained feature set that is extracted by the extraction module 402 and in the each to-be-trained image and the first to-be-trained label and the second to-be-trained label that are obtained by the obtaining module and that correspond to the each to-be-trained image.

In this embodiment, the obtaining module 401 obtains a to-be-trained image set. The to-be-trained image set includes N to-be-trained images, N being an integer greater than or equal to 1. The extraction module 402 extracts a to-be-trained feature set from each to-be-trained image obtained by the obtaining module 401. The to-be-trained feature set includes a first to-be-trained feature, a second to-be-trained feature, and a third to-be-trained feature, the first to-be-trained feature represents an image feature of a first region, the second to-be-trained feature represents an image feature of a second region, the third to-be-trained feature represents an attribute feature related to an interaction operation, and a range of the first region is smaller than a range of the second region. The obtaining module 401 obtains a first to-be-trained label and a second to-be-trained label that correspond to the each to-be-trained image. The first to-be-trained label represents a label related to operation content, and the second to-be-trained label represents a label related to an operation intention. The training module 403 obtains the combined model through training according to the to-be-trained feature set extracted by the extraction module 402 from the each to-be-trained image and the first to-be-trained label and the second to-be-trained label that are obtained by the obtaining module and that correspond to the each to-be-trained image.

In the embodiments of this application, a server is introduced. The server first obtains a to-be-trained image set, and then extracts a to-be-trained feature set from each to-be-trained image. The to-be-trained feature set includes a first to-be-trained feature, a second to-be-trained feature, and a third to-be-trained feature. The server then needs to obtain a first to-be-trained label and a second to-be-trained label that correspond to the each to-be-trained image, and finally obtains the combined model through training according to the to-be-trained feature set in the each to-be-trained image and the first to-be-trained label and the second to-be-trained label that correspond to the each to-be-trained image. According to the foregoing manners, a model that can predict micro control and a big picture at the same time is designed. Therefore, the big picture model and the micro control model are merged into a combined model, thereby effectively resolving a hard handover problem in a hierarchical model and improving the convenience of prediction. In addition, in consideration of that the big picture task may effectively improve the accuracy of macroscopic decision making, and the big picture decision is quite important in a MOBA game especially.

Optionally, based on the embodiment corresponding to FIG. 20, in another embodiment of the server 40 according to an embodiment of this application, the first to-be-trained feature is a two-dimensional vector feature, and the first to-be-trained feature includes at least one of character position information, moving object position information, fixed object position information, and defensive object position information in the first region;

the second to-be-trained feature is a two-dimensional vector feature, and the second to-be-trained feature includes at least one of character position information, moving object position information, fixed object position information, defensive object position information, obstacle object position information, and output object position information in the second region;

the third to-be-trained feature is a one-dimensional vector feature, and the third to-be-trained feature includes at least one of a character hit point value, a character output value, time information, and score information; and

there is a correspondence between the first to-be-trained feature, the second to-be-trained feature, and the third to-be-trained feature.

In the embodiments of this application, content of the three to-be-trained features is also introduced, where the first to-be-trained feature is a two-dimensional vector feature, the second to-be-trained feature is a two-dimensional vector feature, and the third to-be-trained feature is a one-dimensional vector feature. According to the foregoing manners, on one hand, specific information included in the three to-be-trained features may be determined, and more information is therefore obtained for model training. On the other hand, both the first to-be-trained feature and the second to-be-trained feature are two-dimensional vector features, which helps to improve a spatial expression of the feature, thereby improving diversity of the feature.

Optionally, based on the embodiment corresponding to FIG. 20, in another embodiment of the server 40 according to an embodiment of this application, the first to-be-trained label includes key type information and/or key parameter information; and

the key parameter information includes at least one of a direction-type parameter, a position-type parameter, and a target-type parameter, the direction-type parameter being used for representing a moving direction of a character, the position-type parameter being used for representing a position of the character, and the target-type parameter being used for representing a to-be-targeted object of the character.

In the embodiments of this application, it is described that the first to-be-trained label includes the key type information and/or the key parameter information, where the key parameter information includes at least one of a direction-type parameter, a position-type parameter, and a target-type parameter, the direction-type parameter being used for representing a moving direction of a character, the position-type parameter being used for representing a position of the character, and the target-type parameter being used for representing a to-be-targeted object of the character. According to the foregoing manners, content of the first to-be-trained label is further refined, and labels are established in a hierarchical manner, which may be closer to the real operation intention of the human player in the game process, thereby helping to improve a learning capability of AI.

Optionally, based on the embodiment corresponding to FIG. 20, in another embodiment of the server 40 according to an embodiment of this application, the second to-be-trained label includes operation intention information and character position information; and

the operation intention information represents an intention with which a character interacts with an object, and the character position information represents a position of the character in the first region.

In the embodiments of this application, it is described that the second to-be-trained label includes the operation intention information and the character position information, where the operation intention information represents an intention with which a character interacts with an object, and the character position information represents a position of the character in the first region. According to the foregoing manners, the big picture of the human player is reflected by the operation intention information and the character position information jointly. In a MOBA game, a big picture decision is quite important, so that feasibility and operability of the solution are improved.

Optionally, based on the embodiment corresponding to FIG. 20, in another embodiment of the server 40 according to an embodiment of this application, the training module 403 is configured to process the to-be-trained feature set in the each to-be-trained image to obtain a target feature set, the target feature set including a first target feature, a second target feature, and a third target feature;

obtain a first predicted label and a second predicted label that correspond to the target feature set by using an LSTM layer, the first predicted label representing a label that is obtained through prediction and that is related to the operation content, and the second predicted label representing a label that is obtained through prediction and that is related to the operation intention;

obtain a model core parameter through training according to the first predicted label, the first to-be-trained label, the second predicted label, and the second to-be-trained label of the each to-be-trained image, both the first predicted label and the second predicted label being predicted values, and both the first to-be-trained label and the second to-be-trained label being true values; and

generate the combined model according to the model core parameter.

In the embodiments of this application, a process of obtaining the combined model through training is provided, and the process mainly includes processing the to-be-trained feature set of the each to-be-trained image to obtain the target feature set. The first predicted label and the second predicted label that correspond to the target feature set are then obtained by using the LSTM layer, and the model core parameter is obtained through training according to the first predicted label, the first to-be-trained label, the second predicted label, and the second to-be-trained label of the each to-be-trained image. The model core parameter is used for generating the combined model. According to the foregoing manners, a problem that some visual fields are unobservable may be resolved by using the LSTM layer. That is, the LSTM layer may obtain data within a previous period of time, so that the data may be more complete, which helps to make inference and decision in the process of model training.

Optionally, based on the embodiment corresponding to FIG. 20, in another embodiment of the server 40 according to an embodiment of this application, the training module 403 is configured to process the third to-be-trained feature in the each to-be-trained image by using an FC layer to obtain the third target feature, the third target feature being a one-dimensional vector feature;

process the second to-be-trained feature in the each to-be-trained image by using a convolutional layer to obtain the second target feature, the second target feature being a one-dimensional vector feature; and

process the first to-be-trained feature in the each to-be-trained image by using the convolutional layer to obtain the first target feature, the first target feature being a one-dimensional vector feature.

In the embodiments of this application, the to-be-trained feature set may be further processed. That is, the first to-be-trained feature in the each to-be-trained image is processed by using the FC layer to obtain the first target feature, the second to-be-trained feature in the each to-be-trained image is processed by using the convolutional layer to obtain the second target feature, and the third to-be-trained feature in the each to-be-trained image is processed by using the convolutional layer to obtain the third target feature. According to the foregoing manners, one-dimensional vector features may be obtained, and concatenation processing may be performed on the vector features for subsequent model training, thereby helping to improve feasibility and operability of the solution.

Optionally, based on the embodiment corresponding to FIG. 20, in another embodiment of the server 40 according to an embodiment of this application, the training module 403 is configured to obtain a first predicted label, a second predicted label, and a third predicted label that correspond to the target feature set by using the LSTM layer, the third predicted label representing a label that is obtained through prediction and that is related to a victory or a defeat;

obtain a third to-be-trained label corresponding to the each to-be-trained image, the third to-be-trained label being used for representing an actual victory or defeat; and

obtain the model core parameter through training according to the first predicted label, the first to-be-trained label, the second predicted label, the second to-be-trained label, the third predicted label, and the third to-be-trained label, the third to-be-trained label being a predicted value, and the third predicted label being a true value.

In the embodiments of this application, it is described that the combined model may further train a label related to victory or defeat. That is, the server obtains, by using the LSTM layer, the first predicted label, the second predicted label, and the third predicted label that correspond to the target feature set, where the third predicted label represents a label that is obtained through prediction and that is related to a victory or a defeat. Then the server obtains the third to-be-trained label corresponding to the each to-be-trained image, and finally obtains the model core parameter through training according to the first predicted label, the first to-be-trained label, the second predicted label, the second to-be-trained label, the third predicted label, and the third to-be-trained label. According to the foregoing manners, the combined model may further predict a winning percentage of a match. Therefore, awareness and learning of a situation may be reinforced, thereby improving reliability and diversity of model application.

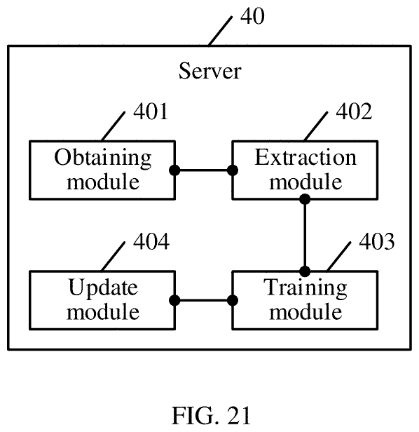

Optionally, based on the embodiment corresponding to FIG. 20, referring to FIG. 21, in another embodiment of the server 40 according to an embodiment of this application, the server 40 further includes an update module 404;

the obtaining module 401 is further configured to obtain a to-be-trained video after the training module 403 obtains the combined model through training according to the to-be-trained feature set in the each to-be-trained image and the first to-be-trained label and the second to-be-trained label that correspond to the each to-be-trained image, the to-be-trained video including a plurality of frames of interaction images;

the obtaining module 401 is further configured to obtain target scene data corresponding to the to-be-trained video by using the combined model, the target scene data including related data in a target scene;

the training module 403 is further configured to obtain a target model parameter through training according to the target scene data, the first to-be-trained label, and the first predicted label that are obtained by the obtaining module 401, the first predicted label representing a label that is obtained through prediction and that is related to the operation content, the first predicted label being a predicted value, and the first to-be-trained label being a true value; and

the update module 404 is configured to update the combined model by using the target model parameter that is obtained by the training module 403, to obtain a reinforced combined model.

Further, in the embodiments of this application, some task layers in the combined model may be further optimized through reinforcement learning, and if a part of the micro control task needs to be reinforced, the server obtains the to-be-trained video. The server then obtains the target scene data corresponding to the to-be-trained video by using the combined model, and obtains the target model parameter through training based on the target scene data, the first to-be-trained label, and the first predicted label. Finally, the server updates the combined model by using the target model parameter to obtain the reinforced combined model. According to the foregoing manners, AI capabilities may be improved by reinforcing the micro control FC layer. In addition, reinforcement learning may further overcome misoperation problems caused by various factors such as nervousness or inattention of a human, thereby greatly reducing a number of bad samples in training data, and further improving reliability of the model and accuracy of performing prediction by using the model. The reinforcement learning method may only reinforce some scenes, to reduce the number of steps of a decision and accelerate convergence.

Optionally, based on the embodiment corresponding to FIG. 20, referring to FIG. 21 again, in another embodiment of the server 40 according to an embodiment of this application, the server 40 further includes an update module 404;

the obtaining module 401 is further configured to obtain a to-be-trained video after the training module 403 obtains the combined model through training according to the to-be-trained feature set in the each to-be-trained image and the first to-be-trained label and the second to-be-trained label that correspond to the each to-be-trained image, the to-be-trained video including a plurality of frames of interaction images;

the obtaining module 401 is further configured to obtain target scene data corresponding to the to-be-trained video by using the combined model, the target scene data including related data in a target scene;

the training module 403 is further configured to obtain a target model parameter through training according to the target scene data, the second to-be-trained label, and the second predicted label that are obtained by the obtaining module 401, the second predicted label representing a label that is obtained through prediction and that is related to the operation intention, the second predicted label being a predicted value, and the second to-be-trained label being a true value; and

the update module 404 is configured to update the combined model by using the target model parameter that is obtained by the training module 403, to obtain a reinforced combined model.

Further, in the embodiments of this application, some task layers in the combined model may be further optimized through reinforcement learning, and if a part of the big-picture task needs to be reinforced, the server obtains the to-be-trained video. The server then obtains the target scene data corresponding to the to-be-trained video by using the combined model, and obtains the target model parameter through training based on the target scene data, the second to-be-trained label, and the second predicted label. Finally, the server updates the combined model by using the target model parameter to obtain the reinforced combined model. According to the foregoing manners, AI capabilities may be improved by reinforcing the big picture FC layer. In addition, reinforcement learning may further overcome misoperation problems caused by various factors such as nervousness or inattention of a human, thereby greatly reducing a number of bad samples in training data, and further improving reliability of the model and accuracy of performing prediction by using the model. The reinforcement learning method may only reinforce some scenes, to reduce the number of steps of a decision and accelerate convergence.

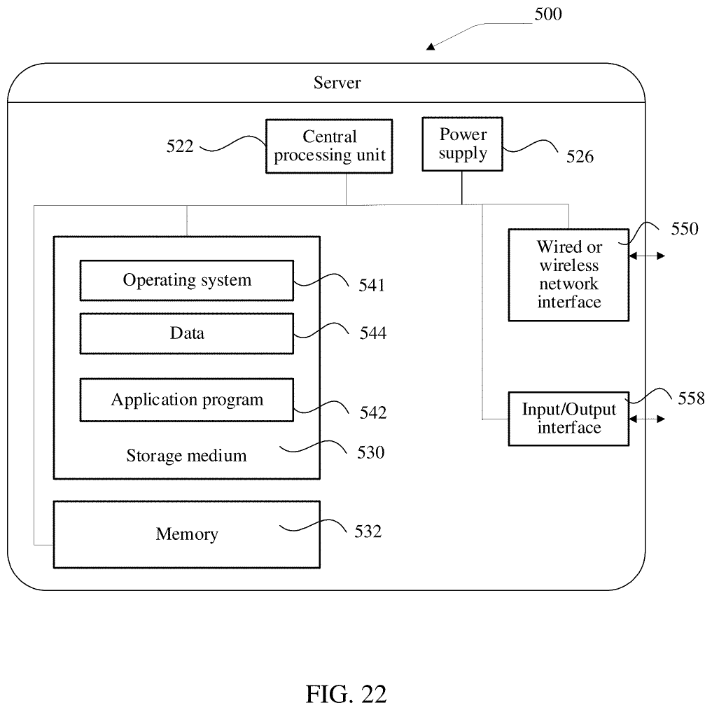

FIG. 22 is a schematic structural diagram of a server according to an embodiment of this application. The server 500 may vary greatly due to different configurations or performance, and may include one or more central processing units (CPU) 522 (for example, one or more processors) and a memory 532, and one or more storage media 530 (for example, one or more mass storage devices) that store application programs 542 or data 544. The memory 532 and the storage medium 530 may be temporary storage or persistent storage. A program stored in the storage medium 530 may include one or more modules (which are not marked in the figure), and each module may include a series of instruction operations on the server. Further, the CPU 522 may be set to communicate with the storage medium 530, and perform, on the server 500, the series of instruction operations in the storage medium 530.

The server 500 may further include one or more power supplies 526, one or more wired or wireless network interfaces 550, one or more input/output interfaces 558, and/or one or more operating systems 541 such as Windows Server™, Mac OS X™, Unix™, Linux, or FreeBSD™.

The steps performed by the server in the foregoing embodiments may be based on the server structure shown in FIG. 22.

In this embodiment of this application, the CPU 522 is configured to perform the following steps:

obtaining a to-be-predicted image;

extracting a to-be-predicted feature set from the to-be-predicted image, the to-be-predicted feature set including a first to-be-predicted feature, a second to-be-predicted feature, and a third to-be-predicted feature, the first to-be-predicted feature representing an image feature of a first region, the second to-be-predicted feature representing an image feature of a second region, the third to-be-predicted feature representing an attribute feature related to an interaction operation, and a range of the first region being smaller than a range of the second region;

obtaining, by using a combined model, a first label and/or a second label that correspond or corresponds to the to-be-predicted feature set, the first label representing a label related to operation content, and the second label representing a label related to an operation intention.

Optionally, the CPU 522 is further configured to perform the following steps:

obtaining, by using the combined model, the first label, the second label, and a third label that correspond to the to-be-predicted feature set, the third label representing a label related to a victory or a defeat.

In this embodiment of this application, the CPU 522 is configured to perform the following steps:

obtaining a to-be-trained image set, the to-be-trained image set including N to-be-trained images, N being an integer greater than or equal to 1;

extracting a to-be-trained feature set from each to-be-trained image, the to-be-trained feature set including a first to-be-trained feature, a second to-be-trained feature, and a third to-be-trained feature, the first to-be-trained feature representing an image feature of a first region, the second to-be-trained feature representing an image feature of a second region, the third to-be-trained feature representing an attribute feature related to an interaction operation, and a range of the first region being smaller than a range of the second region;

obtaining a first to-be-trained label and a second to-be-trained label that correspond to the each to-be-trained image, the first to-be-trained label representing a label related to operation content, and the second to-be-trained label representing a label related to an operation intention;

obtaining a combined model through training according to the to-be-trained feature set in the each to-be-trained image and the first to-be-trained label and the second to-be-trained label that correspond to the each to-be-trained image.

Optionally, the CPU 522 is further configured to perform the following steps:

processing the to-be-trained feature set in the each to-be-trained image to obtain a target feature set, the target feature set including a first target feature, a second target feature, and a third target feature;

obtaining a first predicted label and a second predicted label that correspond to the target feature set by using an LSTM layer, the first predicted label representing a label that is obtained through prediction and that is related to the operation content, and the second predicted label representing a label that is obtained through prediction and that is related to the operation intention;

obtaining a model core parameter through training according to the first predicted label, the first to-be-trained label, the second predicted label, and the second to-be-trained label of the each to-be-trained image, both the first predicted label and the second predicted label being predicted values, and both the first to-be-trained label and the second to-be-trained label being true values; and

generating the combined model according to the model core parameter.

Optionally, the CPU 522 is further configured to perform the following steps:

processing the third to-be-trained feature in the each to-be-trained image by using an FC layer to obtain the third target feature, the third target feature being a one-dimensional vector feature;

processing the second to-be-trained feature in the each to-be-trained image by using a convolutional layer to obtain the second target feature, the second target feature being a one-dimensional vector feature; and

processing the first to-be-trained feature in the each to-be-trained image by using the convolutional layer to obtain the first target feature, the first target feature being a one-dimensional vector feature.

Optionally, the CPU 522 is further configured to perform the following steps:

obtaining a first predicted label, a second predicted label, and a third predicted label that correspond to the target feature set by using the LSTM layer, the third predicted label representing a label that is obtained through prediction and that is related to a victory or a defeat; and

the obtaining a model core parameter through training according to the first predicted label, the first to-be-trained label, the second predicted label, and the second to-be-trained label of the each to-be-trained image includes:

obtaining a third to-be-trained label corresponding to the each to-be-trained image, the third to-be-trained label being used for representing an actual victory or defeat; and

obtaining the model core parameter through training according to the first predicted label, the first to-be-trained label, the second predicted label, the second to-be-trained label, the third predicted label, and the third to-be-trained label, the third to-be-trained label being a predicted value, and the third predicted label being a true value.

Optionally, the CPU 522 is further configured to perform the following steps:

obtaining a to-be-trained video, the to-be-trained video including a plurality of frames of interaction images;

obtaining target scene data corresponding to the to-be-trained video by using the combined model, the target scene data including related data in a target scene;

obtaining a target model parameter through training according to the target scene data, the first to-be-trained label, and the first predicted label, the first predicted label representing a label that is obtained through prediction and that is related to the operation content, the first predicted label being a predicted value, and the first to-be-trained label being a true value; and

updating the combined model by using the target model parameter, to obtain a reinforced combined model.

Optionally, the CPU 522 is further configured to perform the following steps:

obtaining a to-be-trained video, the to-be-trained video including a plurality of frames of interaction images;

obtaining target scene data corresponding to the to-be-trained video by using the combined model, the target scene data including related data in a target scene;

obtaining a target model parameter through training according to the target scene data, the second to-be-trained label, and the second predicted label, the second predicted label representing a label that is obtained through prediction and that is related to the operation intention, the second predicted label being a predicted value, and the second to-be-trained label being a true value; and

updating the combined model by using the target model parameter, to obtain a reinforced combined model.

A person skilled in the art may clearly understand that, for simple and clear description, for specific work processes of the foregoing described system, apparatus, and unit, reference may be made to corresponding processes in the foregoing method embodiments, and details are not described herein again.

In the several embodiments provided in this application, it is to be understood that the disclosed system, apparatus, and method may be implemented in other manners. For example, the described apparatus embodiment is merely exemplary. For example, the unit division is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electric, mechanical, or other forms.

The units described as separate components may or may not be physically separated, and the components displayed as units may or may not be physical units, that is, may be located in one place or may be distributed over a plurality of network units. Some or all of the units may be selected according to actual requirements to achieve the objectives of the solutions in the embodiments.

In addition, functional units in the embodiments of this application may be integrated into one processing unit, or each of the units may exist alone physically, or two or more units are integrated into one unit. The integrated unit may be implemented in the form of hardware, or may be implemented in the form of a software functional unit.

When the integrated unit is implemented in the form of a software functional unit and sold or used as an independent product, the integrated unit may be stored in a computer-readable storage medium. Based on such an understanding, the technical solutions of this application essentially, or the part contributing to the related art, or all or some of the technical solutions may be implemented in the form of a software product. The computer software product is stored in a storage medium and includes several instructions for instructing a computer device (which may be a personal computer, a server, a network device, or the like) to perform all or some of the steps of the methods described in the embodiments of this application. The foregoing storage medium includes: any medium that can store program code, such as a USB flash drive, a removable hard disk, a read-only memory (ROM), a random access memory (RAM), a magnetic disk, or an optical disc.

“Plurality of” mentioned in this specification means two or more. “And/or” describes an association relationship for describing associated objects and represents that three relationships may exist. For example, A and/or B may represent the following three cases: Only A exists, both A and B exist, and only B exists. The character “/” in this specification generally indicates an “or” relationship between the associated objects. “At least one” represents one or more.

The foregoing embodiments are merely provided for describing the technical solutions of this application, but not intended to limit this application. A person of ordinary skill in the art may understand that although this application has been described in detail with reference to the foregoing embodiments, modifications may still be made to the technical solutions described in the foregoing embodiments, or equivalent replacements may be made to some technical features in the technical solutions, provided that such modifications or replacements do not cause the essence of corresponding technical solutions to depart from the spirit and scope of the technical solutions of the embodiments of this application.

What is claimed is:

1. A method for obtaining a combined model, the method comprising:
obtaining, by a device comprising a memory storing instructions and a processor in communication with the memory, a to-be-trained image set, the to-be-trained image set comprising N to-be-trained images, N being an integer greater than or equal to 1;
extracting, by the device, a to-be-trained feature set from each to-be-trained image, the to-be-trained feature set comprising a first to-be-trained feature, a second to-be-trained feature, and a third to-be-trained feature, the first to-be-trained feature representing an image feature of a first region, the second to-be-trained feature representing an image feature of a second region, the third to-be-trained feature representing an attribute feature related to an interaction operation, and a range of the first region being smaller than a range of the second region;
obtaining, by the device, a first to-be-trained label and a second to-be-trained label that correspond to the each to-be-trained image, the first to-be-trained label representing a label related to operation content, and the second to-be-trained label representing a label related to an operation intention; and
obtaining, by the device, a combined model through training according to the to-be-trained feature set in the each to-be-trained image and the first to-be-trained label and the second to-be-trained label that correspond to the each to-be-trained image.

2. The method according to claim 1, wherein:
the first to-be-trained feature is a two-dimensional vector feature, and the first to-be-trained feature comprises at least one of character position information, moving object position information, fixed object position information, or defensive object position information in the first region;
the second to-be-trained feature is a two-dimensional vector feature, and the second to-be-trained feature comprises at least one of character position information, moving object position information, fixed object position information, defensive object position information, obstacle object position information, or output object position information in the second region;
the third to-be-trained feature is a one-dimensional vector feature, and the third to-be-trained feature comprises at least one of a character hit point value, a character output value, time information, or score information; and
correspondence relationship exists between the first to-be-trained feature, the second to-be-trained feature, and the third to-be-trained feature.

3. The method according to claim 1, wherein:
the first to-be-trained label comprises at least one of key type information or key parameter information; and
the key parameter information comprises at least one of a direction-type parameter, a position-type parameter, or a target-type parameter, wherein the direction-type parameter represents a moving direction of a character, the position-type parameter represents a position of the character, and the target-type parameter represents a to-be-targeted object of the character.

4. The method according to claim 1, wherein
the second to-be-trained label comprises at least one of operation intention information or character position information; and
the operation intention information represents an intention with which a character interacts with an object, and the character position information represents a position of the character in the first region.

5. The method according to claim 1, wherein the obtaining the combined model through training according to the to-be-trained feature set in the each to-be-trained image and the first to-be-trained label and the second to-be-trained label that correspond to the each to-be-trained image comprises:
processing the to-be-trained feature set in the each to-be-trained image to obtain a target feature set, the target feature set comprising a first target feature, a second target feature, and a third target feature;
obtaining a first predicted label and a second predicted label that correspond to the target feature set by using a long short-term memory (LSTM) layer, the first predicted label representing a label that is obtained through prediction and that is related to the operation content, and the second predicted label representing a label that is obtained through prediction and that is related to the operation intention;
obtaining a model core parameter through training according to the first predicted label, the first to-be-trained label, the second predicted label, and the second to-be-trained label of the each to-be-trained image, both the first predicted label and the second predicted label being predicted values, and both the first to-be-trained label and the second to-be-trained label being true values; and
generating the combined model according to the model core parameter.

6. The method according to claim 5, wherein the processing the to-be-trained feature set in the each to-be-trained image to obtain the target feature set comprises:
processing the third to-be-trained feature in the each to-be-trained image by using a fully connected layer to obtain the third target feature, the third target feature being a one-dimensional vector feature;
processing the second to-be-trained feature in the each to-be-trained image by using a convolutional layer to obtain the second target feature, the second target feature being a one-dimensional vector feature; and
processing the first to-be-trained feature in the each to-be-trained image by using the convolutional layer to obtain the first target feature, the first target feature being a one-dimensional vector feature.

7. The method according to claim 1, wherein, after the obtaining the combined model through training according to the to-be-trained feature set in the each to-be-trained image and the first to-be-trained label and the second to-be-trained label that correspond to the each to-be-trained image, the method further comprises:
obtaining a to-be-trained video, the to-be-trained video comprising a plurality of frames of interaction images;
obtaining target scene data corresponding to the to-be-trained video by using the combined model, the target scene data comprising related data in a target scene;
obtaining a target model parameter through training according to the target scene data, the first to-be-trained label, and a first predicted label, the first predicted label representing a label that is obtained through prediction and that is related to the operation content, the first predicted label being a predicted value, and the first to-be-trained label being a true value; and
updating the combined model by using the target model parameter, to obtain a reinforced combined model.

8. An apparatus for obtaining a combined model, the apparatus comprising:
a memory storing instructions; and
a processor in communication with the memory, wherein, when the processor executes the instructions, the processor is configured to cause the apparatus to:
obtain a to-be-trained image set, the to-be-trained image set comprising N to-be-trained images, N being an integer greater than or equal to 1,
extract a to-be-trained feature set from each to-be-trained image, the to-be-trained feature set comprising a first to-be-trained feature, a second to-be-trained feature, and a third to-be-trained feature, the first to-be-trained feature representing an image feature of a first region, the second to-be-trained feature representing an image feature of a second region, the third to-be-trained feature representing an attribute feature related to an interaction operation, and a range of the first region being smaller than a range of the second region,
obtain a first to-be-trained label and a second to-be-trained label that correspond to the each to-be-trained image, the first to-be-trained label representing a label related to operation content, and the second to-be-trained label representing a label related to an operation intention, and
obtain a combined model through training according to the to-be-trained feature set in the each to-be-trained image and the first to-be-trained label and the second to-be-trained label that correspond to the each to-be-trained image.

9. The apparatus according to claim 8, wherein:
the first to-be-trained feature is a two-dimensional vector feature, and the first to-be-trained feature comprises at least one of character position information, moving object position information, fixed object position information, or defensive object position information in the first region;
the second to-be-trained feature is a two-dimensional vector feature, and the second to-be-trained feature comprises at least one of character position information, moving object position information, fixed object position information, defensive object position information, obstacle object position information, or output object position information in the second region;
the third to-be-trained feature is a one-dimensional vector feature, and the third to-be-trained feature comprises at least one of a character hit point value, a character output value, time information, or score information; and
correspondence relationship exists between the first to-be-trained feature, the second to-be-trained feature, and the third to-be-trained feature.

10. The apparatus according to claim 8, wherein:
the first to-be-trained label comprises at least one of key type information or key parameter information; and
the key parameter information comprises at least one of a direction-type parameter, a position-type parameter, or a target-type parameter, wherein the direction-type parameter represents a moving direction of a character, the position-type parameter represents a position of the character, and the target-type parameter represents a to-be-targeted object of the character.

11. The apparatus according to claim 8, wherein:
the second to-be-trained label comprises at least one of operation intention information or character position information; and
the operation intention information represents an intention with which a character interacts with an object, and the character position information represents a position of the character in the first region.

12. The apparatus according to claim 8, wherein, when the processor is configured to cause the apparatus to obtain the combined model through training according to the to-be-trained feature set in the each to-be-trained image and the first to-be-trained label and the second to-be-trained label that correspond to the each to-be-trained image, the processor is configured to cause the apparatus to:
process the to-be-trained feature set in the each to-be-trained image to obtain a target feature set, the target feature set comprising a first target feature, a second target feature, and a third target feature;
obtain a first predicted label and a second predicted label that correspond to the target feature set by using a long short-term memory (LSTM) layer, the first predicted label representing a label that is obtained through prediction and that is related to the operation content, and the second predicted label representing a label that is obtained through prediction and that is related to the operation intention;
obtain a model core parameter through training according to the first predicted label, the first to-be-trained label, the second predicted label, and the second to-be-trained label of the each to-be-trained image, both the first predicted label and the second predicted label being predicted values, and both the first to-be-trained label and the second to-be-trained label being true values; and
generate the combined model according to the model core parameter.

13. The apparatus according to claim 12, wherein, when the processor is configured to cause the apparatus to process the to-be-trained feature set in the each to-be-trained image to obtain the target feature set, the processor is configured to cause the apparatus to:
process the third to-be-trained feature in the each to-be-trained image by using a fully connected layer to obtain the third target feature, the third target feature being a one-dimensional vector feature;
process the second to-be-trained feature in the each to-be-trained image by using a convolutional layer to obtain the second target feature, the second target feature being a one-dimensional vector feature; and
process the first to-be-trained feature in the each to-be-trained image by using the convolutional layer to obtain the first target feature, the first target feature being a one-dimensional vector feature.

14. The apparatus according to claim 8, wherein, after the processor is configured to cause the apparatus to obtain the combined model through training according to the to-be-trained feature set in the each to-be-trained image and the first to-be-trained label and the second to-be-trained label that correspond to the each to-be-trained image, the processor is configured to further cause the apparatus to:
obtain a to-be-trained video, the to-be-trained video comprising a plurality of frames of interaction images;
obtain target scene data corresponding to the to-be-trained video by using the combined model, the target scene data comprising related data in a target scene;
obtain a target model parameter through training according to the target scene data, the first to-be-trained label, and a first predicted label, the first predicted label representing a label that is obtained through prediction and that is related to the operation content, the first predicted label being a predicted value, and the first to-be-trained label being a true value; and
update the combined model by using the target model parameter, to obtain a reinforced combined model.

15. A non-transitory computer-readable storage medium storing computer-readable instructions, wherein, the computer-readable instructions, when executed by a processor, are configured to cause the processor to perform:
obtaining a to-be-trained image set, the to-be-trained image set comprising N to-be-trained images, N being an integer greater than or equal to 1;
extracting a to-be-trained feature set from each to-be-trained image, the to-be-trained feature set comprising a first to-be-trained feature, a second to-be-trained feature, and a third to-be-trained feature, the first to-be-trained feature representing an image feature of a first region, the second to-be-trained feature representing an image feature of a second region, the third to-be-trained feature representing an attribute feature related to an interaction operation, and a range of the first region being smaller than a range of the second region;
obtaining a first to-be-trained label and a second to-be-trained label that correspond to the each to-be-trained image, the first to-be-trained label representing a label related to operation content, and the second to-be-trained label representing a label related to an operation intention; and
obtaining a combined model through training according to the to-be-trained feature set in the each to-be-trained image and the first to-be-trained label and the second to-be-trained label that correspond to the each to-be-trained image.

16. The non-transitory computer-readable storage medium according to claim 15, wherein:
the first to-be-trained feature is a two-dimensional vector feature, and the first to-be-trained feature comprises at least one of character position information, moving object position information, fixed object position information, or defensive object position information in the first region;
the second to-be-trained feature is a two-dimensional vector feature, and the second to-be-trained feature comprises at least one of character position information, moving object position information, fixed object position information, defensive object position information, obstacle object position information, or output object position information in the second region;
the third to-be-trained feature is a one-dimensional vector feature, and the third to-be-trained feature comprises at least one of a character hit point value, a character output value, time information, or score information; and
correspondence relationship exists between the first to-be-trained feature, the second to-be-trained feature, and the third to-be-trained feature.

17. The non-transitory computer-readable storage medium according to claim 15, wherein:
the first to-be-trained label comprises at least one of key type information or key parameter information; and
the key parameter information comprises at least one of a direction-type parameter, a position-type parameter, or a target-type parameter, wherein the direction-type parameter represents a moving direction of a character, the position-type parameter represents a position of the character, and the target-type parameter represents a to-be-targeted object of the character.

18. The non-transitory computer-readable storage medium according to claim 15, wherein:
the second to-be-trained label comprises at least one of operation intention information or character position information; and
the operation intention information represents an intention with which a character interacts with an object, and the character position information represents a position of the character in the first region.

19. The non-transitory computer-readable storage medium according to claim 15, wherein, when the computer-readable instructions are configured to cause the processor to perform obtaining the combined model through training according to the to-be-trained feature set in the each to-be-trained image and the first to-be-trained label and the second to-be-trained label that correspond to the each to-be-trained image, the computer-readable instructions are configured to cause the processor to perform:
processing the to-be-trained feature set in the each to-be-trained image to obtain a target feature set, the target feature set comprising a first target feature, a second target feature, and a third target feature;
obtaining a first predicted label and a second predicted label that correspond to the target feature set by using a long short-term memory (LSTM) layer, the first predicted label representing a label that is obtained through prediction and that is related to the operation content, and the second predicted label representing a label that is obtained through prediction and that is related to the operation intention;
obtaining a model core parameter through training according to the first predicted label, the first to-be-trained label, the second predicted label, and the second to-be-trained label of the each to-be-trained image, both the first predicted label and the second predicted label being predicted values, and both the first to-be-trained label and the second to-be-trained label being true values; and
generating the combined model according to the model core parameter.

20. The non-transitory computer-readable storage medium according to claim 19, wherein, when the computer-readable instructions are configured to cause the processor to perform processing the to-be-trained feature set in the each to-be-trained image to obtain the target feature set, the computer-readable instructions are configured to cause the processor to perform:
processing the third to-be-trained feature in the each to-be-trained image by using a fully connected layer to obtain the third target feature, the third target feature being a one-dimensional vector feature;
processing the second to-be-trained feature in the each to-be-trained image by using a convolutional layer to obtain the second target feature, the second target feature being a one-dimensional vector feature; and
processing the first to-be-trained feature in the each to-be-trained image by using the convolutional layer to obtain the first target feature, the first target feature being a one-dimensional vector feature.
